(19) United States
(12) Patent Application Publication
(10) Pub. No.: US 2025/0214259 A1
(43) Pub. Date: Jul. 3, 2025

(54) MECHANICAL END EFFECTOR

(71) Applicant: Figure AI Inc., Sunnyvale, CA (US)

(72) Inventors: Jake Goldsmith, Sunnyvale, CA (US); Michael Stevens, Sunnyvale, CA (US); Jacob Daniel Webb, Sunnyvale, CA (US)

(21) Appl. No.: 19/006,191

(22) Filed: Dec. 30, 2024

Related U.S. Application Data
(60) Provisional application No. 63/615,766, filed on Dec. 28, 2023.
(60) Provisional application No. 63/617,762, filed on Jan. 4, 2024.
(60) Provisional application No. 63/561,315, filed on Mar. 5, 2024.
(60) Provisional application No. 63/573,226, filed on Apr. 2, 2024.
(60) Provisional application No. 63/620,633, filed on Jan. 12, 2024.

(51) Int. Cl. B25J 15/02; B25J 15/00

(52) U.S. Cl. CPC B25J 15/0213; B25J 15/0009

(57) ABSTRACT

The present disclosure provides an underactuated end effector for a humanoid robot. The end effector includes a frame, a plurality of finger assemblies removably connected to the frame, and a thumb assembly removably connected to the frame. Each finger assembly includes a finger motor assembly. The thumb assembly includes a first thumb motor with a first thumb motor shaft configured to rotate about a first motor shaft axis, and a first motor gear connected to the first thumb motor shaft. The thumb assembly also includes a second thumb motor with a second thumb motor shaft configured to rotate about a second motor shaft axis, and a second motor gear connected to the second thumb motor shaft. The first motor shaft axis is substantially parallel to the second motor shaft axis, and the first motor gear axis is substantially parallel to the second motor gear axis.

### CROSS-REFERENCE TO RELATED APPLICATIONS

This application claims benefit under 35 U.S.C. § 119 of U.S. Provisional Patent Applications Nos. 63/617,762, 63/561,315, 63/573,226, 63/615,766, 63/620,633 all of which are incorporated herein by reference for any purpose. U.S. patent application Ser. Nos. 19/000,626, 18/919,263 and 18/919,274, and U.S. Provisional Patent Application Nos. 63/614,499, 63/557,874, 63/626,040, 63/626,105, 63/625,362, 63/625,370, 63/625,381, 63/625,384, 63/625,389, 63/625,405, 63/625,423, 63/625,431, 63/685,856, 63/696,507, 63/696,533, 63/706,768, 63/722,057, and 63/700,749 are all incorporated herein by reference for any purpose.

### TECHNICAL FIELD

This disclosure relates to a mechanical end effector for a robot, specifically a general-purpose humanoid robot. The mechanical end effector includes various assemblies, components contained in the various assemblies, and connections between said components that provide the mechanical end effector with the ability to substantially mimic the movements, capabilities, and configuration of a human hand.

### BACKGROUND

The current workplace landscape is marked by an unparalleled labor shortage, evident in over 10 million unsafe or undesirable jobs within the United States. These positions often encompass tasks in high-risk sectors—such as manufacturing, construction, and materials handling—where human labor faces safety challenges or heightened physical strain. To mitigate this widening labor gap, there is a pronounced need for high-performance robotic systems that can assume responsibility for a variety of demanding, repetitive, or potentially dangerous operations. Consequently, ongoing advancements in robotics research have concentrated on the development of sophisticated, general-purpose humanoid robots, which are specifically engineered to function within environments originally designed for human workers. These general-purpose humanoid robots are equipped with hardware and software architectures optimized for performing diverse tasks with efficiency, accuracy, and reliability in human-centric environments.

In order to fulfill the functional and ergonomic requirements of human-centric environments, general-purpose humanoid robots are commonly outfitted with anthropomorphic features, including two legs, two arms, a torso, and a head or face-like interface that may provide user feedback or display information. Central to this anthropomorphic design philosophy is the mechanical end effector of the robot, which should be able to approximate most of the capability of the human hand in terms of dexterity, strength, and overall versatility. By being able to approximate most of the capability of the human hand, the end effector can more effectively interact with complex, real-world objects, thereby performing functions such as grasping, rotating, and manipulating items with minimal risk of slippage or damage. In addition to providing a high level of dexterity, the design must satisfy operational constraints related to energy consumption, cost efficiency, and mechanical durability. As such, there is a need for a mechanical end effector that can provide humanoid robots with the ability to execute tasks with human-equivalent precision, robustness, and adaptability in dynamic and unpredictable work environments.

### SUMMARY

According to an aspect of the present disclosure, an underactuated end effector for a humanoid robot is provided. The end effector includes a frame, a plurality of finger assemblies removably connected to the frame, and a thumb assembly removably connected to the frame. Each finger assembly of the plurality of finger assemblies includes a finger motor assembly. The thumb assembly comprises a first thumb motor with a first thumb motor shaft configured to rotate about a first motor shaft axis, a first motor gear connected to the first thumb motor shaft and configured for rotation about the first motor shaft and a first motor gear axis, a second thumb motor with a second thumb motor shaft configured to rotate about a second motor shaft axis, and a second motor gear connected to the second thumb motor shaft and configured for rotation about the second motor shaft and a second motor gear axis. The first motor shaft and the first motor gear axis are coaxial, and the second motor shaft and the second motor gear axis are coaxial. The first motor shaft axis is substantially parallel to the second motor shaft axis, and the first motor gear axis is substantially parallel to the second motor gear axis.

According to another aspect of the present disclosure, an underactuated end effector for a humanoid robot is provided. The end effector includes a frame, a plurality of finger assemblies connected to the frame, and a thumb assembly removably connected to the frame. Each finger assembly of the plurality of finger assemblies comprises a metacarpophalangeal joint MCP, a proximal finger interphalangeal joint PIP, and a distal finger interphalangeal joint DIP. The thumb assembly comprises a first carpometacarpal joint CMC₁, a second carpometacarpal joint CMC₂, a metacarpophalangeal joint MCP, an interphalangeal joint DIP. A carpometacarpal encoder positioned proximate the first carpometacarpal joint and configured to collect data related to rotation of the first carpometacarpal joint, a first thumb encoder positioned proximate the metacarpophalangeal joint and configured to collect data related to rotation of the metacarpophalangeal joint, and a second thumb encoder positioned proximate the interphalangeal joint and configured to collect data related to rotation of the interphalangeal joint. The first thumb encoder and second thumb encoder are positioned adjacent to a main medial link of the thumb assembly.

According to a further aspect of the present disclosure, an underactuated end effector for a humanoid robot is provided. The end effector includes a palm housing coupled to an end effector frame and having a sagittal plane, a plurality of finger assemblies removably connected to a first side of the end effector frame, and a thumb assembly removably connected to a second side of the end effector frame. The sagittal plane is aligned with a longitudinal plane of a finger assembly of the plurality of finger assemblies. The thumb assembly comprises a thumb motor assembly, which includes a first thumb motor with a first thumb motor shaft configured to rotate about a first motor shaft axis, and a second thumb motor with a second thumb motor shaft configured to rotate about a second motor shaft axis. At least an extent of the first thumb motor and the second thumb motor underlie the palm housing. Both of the first thumb motor shaft axis and the second thumb motor shaft axis are not parallel with the sagittal plane.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a perspective view of a wrist coupler and a mechanical end effector that is designed to emulate a human left hand, wherein the mechanical end effector includes a plurality of finger assemblies, a thumb assembly, a housing, and electronics for controlling the finger assemblies and the thumb assembly;

FIG. 2 is a perspective view of the wrist coupler and the mechanical end effector of FIG. 1, wherein said wrist coupler is removably secured to a lower extent of a robot arm;

FIG. 3 is a front or palm view of the mechanical end effector of FIGS. 1-2;

FIG. 4 is a back or top view of the mechanical end effector of FIGS. 1-2;

FIG. 5 is a right side or thumb view of the mechanical end effector of FIGS. 1-2;

FIG. 6 is a left side or finger view of the mechanical end effector of FIGS. 1-2;

FIG. 7 is a bottom view of the mechanical end effector of FIGS. 1-2;

FIG. 8 is a top view of the mechanical end effector of FIGS. 1-2;

FIG. 9 is a perspective view of the mechanical end effector of FIGS. 1-2, wherein an extent of the housing has been removed to show a portion of the components contained within said housing;

FIG. 10 is a front or palm view of the mechanical end effector of FIGS. 1-2, wherein an extent of the housing has been removed to show a portion of the components contained within said housing;

FIG. 11 is a top perspective view of the thumb assembly of the mechanical end effector of FIGS. 1-2 in a partially curled configuration, wherein said thumb assemblies includes a base joint assembly and a digit assembly;

FIG. 12 is a bottom perspective view of the thumb assembly of FIGS. 1-2 in the partially curled configuration includes: (i) a motor assembly with drive gears, (ii) a base joint assembly, (iii) a proximal assembly, (iv) a medial assembly, and (v) a distal assembly;

FIG. 13 is a right side view of the thumb assembly of FIGS. 11-12;

FIG. 14 is a left side view of the thumb assembly of FIGS. 11-12;

FIG. 15 is a top view of the thumb assembly of FIGS. 11-12;

FIG. 16 is a bottom view of the thumb assembly of FIGS. 11-12;

FIG. 17 is a front or palm view of the thumb assembly of FIGS. 11-12;

FIG. 18 is a back or top view of the thumb assembly of FIGS. 11-12;

FIG. 19 is a top view of the thumb assembly of FIGS. 11-12 in an uncurled configuration;

FIG. 20 is a cross-sectional view of the thumb assembly taken along line 20-20 of FIG. 19;

FIG. 21 is a cross-sectional view of the thumb assembly taken along line 21-21 of FIG. 19;

FIG. 22 is a cross-sectional view of the thumb assembly taken along line 22-22 of FIG. 19;

FIG. 23 is a top view of the thumb assembly of FIGS. 11-12 in a curled configuration;

FIG. 24 is a cross-sectional view of the thumb assembly taken along line 24-24 of FIG. 23;

FIG. 25 is a front or palm view of the thumb assembly of FIGS. 11-12 in the uncurled configuration;

FIG. 26 is a cross-sectional view of the thumb assembly taken along line 26-26 of FIG. 25;

FIG. 27 is a cross-sectional view of the thumb assembly taken along line 27-27 of FIG. 25;

FIGS. 28A-28D show a front or palm view of the thumb assembly of FIGS. 11-12, wherein the housing assemblies have been omitted to better illustrate the inner linkages of said thumb assembly;

FIG. 29 is a diagram showing layers of materials contained in the housing of the thumb assembly of FIGS. 11-12;

FIG. 30 is a perspective view of the motor assembly and its gear assembly of FIGS. 11-12;

FIG. 31A is a right side view of the motor assembly of FIG. 29;

FIG. 31B is a palm view of the motor assembly of FIG. 29;

FIG. 32 is a perspective view of the digit assembly of FIGS. 11-12, and wherein said digit assembly includes a proximal assembly, a medial assembly, and a distal assembly;

FIG. 33 is a front or palm view of the digit assembly of FIGS. 11-12;

FIG. 34 is an exploded view of the base joint assembly and the digit assembly of the thumb assembly of FIGS. 11-12;

FIG. 35 is a perspective view of a proximal assembly of the digit assembly of FIGS. 11-12 and 32-33, wherein said proximal assembly includes a proximal housing and a proximal link assembly;

FIG. 36 is a right side view of the proximal assembly of FIG. 35;

FIG. 37 is a cross-sectional side view of the proximal assembly taken along line 37-37 of FIG. 36;

FIG. 38 is a perspective view of the proximal link assembly FIG. 35;

FIG. 39 is a front view of the proximal link assembly FIG. 38;

FIG. 40 is an exploded view of the proximal link assembly of FIG. 38, wherein said proximal link assembly includes a primary or main proximal link, a coupling link, a medial assembly coupler, and a proximal drive link assembly;

FIG. 41 is a perspective view of the proximal drive link assembly of FIG. 40, and wherein said proximal drive link assembly includes worm wheel, a worm wheel coupler, a worm drive link or second bar, and a jumper or third bar;

FIG. 42 is a front or palm view of the proximal drive link assembly of FIG. 40;

FIG. 43 is a right side view of the proximal drive link assembly of FIG. 40;

FIG. 44 is a perspective view of the worm wheel coupler of FIG. 41;

FIG. 45 is a front or palm view of the worm wheel coupler of FIG. 41;

FIG. 46 is a perspective view of the worm drive link of FIG. 41;

FIG. 47 is a front or palm view of the worm drive link of FIG. 41;

FIG. 48 is a first perspective view of the main proximal link of FIG. 40;

FIG. 49 is a second perspective view of the main proximal link of FIG. 48;

FIG. 50 is a right side view of the main proximal link of FIG. 48;

FIG. 51 is a front or palm view of the main proximal link of FIG. 48;

FIG. 52 is a perspective view of the coupling link of FIG. 40;

FIG. 53 is a front or palm view of the coupling link of FIG. 52;

FIG. 54 is a bottom view of the coupling link of FIG. 52;

FIG. 55 is a perspective view of the medial assembly of FIGS. 11-12 and 32-33, and wherein said medial assembly includes a medial housing and a medial link assembly;

FIG. 56 is a right side view of the medial assembly of FIG. 55;

FIG. 57 is a cross-sectional view of the medial assembly taken along line 57-57 of FIG. 56;

FIG. 58 is a perspective view of the medial link assembly of FIG. 55;

FIG. 59 is a front or palm view of the medial link assembly of FIG. 58;

FIG. 60 is an exploded view of the medial link assembly of FIG. 58, and wherein said medial link assembly includes a primary or main medial link, a medial drive link, a Y-link, and a biasing assembly;

FIG. 61 is a first perspective view of the main medial link of FIG. 60;

FIG. 62 is a second perspective view of the main medial link of FIG. 61;

FIG. 63 is a front or palm view of the main medial link of FIG. 61;

FIG. 64 is a bottom view of the main medial link of FIG. 61;

FIG. 65 is a first perspective view of the medial drive link of FIG. 60;

FIG. 66 is second perspective view of the medial drive link of FIG. 60;

FIG. 67 is a front or palm view of the medial drive link of FIG. 60;

FIG. 68 is a perspective view of the distal assembly of FIGS. 11-12 and 32-33, and wherein said distal assembly includes a distal housing assembly and a distal link assembly;

FIG. 69 is a top view of the distal assembly of FIG. 68;

FIG. 70 is a cross-sectional view of the distal assembly taken along line 70-70 of FIG. 69, and wherein said distal assembly includes a distal housing assembly and distal link assembly;

FIG. 71 is a perspective view of the distal link assembly of FIG. 70, and wherein said distal link assembly includes a main distal link and a cover;

FIG. 72 is a front or palm view of the distal link assembly of FIG. 71;

FIG. 73 is a first perspective view of the main distal link of FIG. 71;

FIG. 74 is a second perspective view of the main distal link of FIG. 71;

FIG. 75 of a top view of the main distal link of FIG. 72; and

FIG. 76 is a front or palm view of the main distal link of FIG. 73.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present disclosure.

While this disclosure includes several embodiments in many different forms, there is shown in the drawings and will herein be described in detail embodiments with the understanding that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations and several details are capable of being modified all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts may be performed in a different order. Accordingly, the drawings, flow charts and detailed description are to be regarded as illustrative in nature, not restrictive or limiting.

### A. Introduction

The mechanical end effector 10 disclosed in this Application is designed to be a component within a robot system, potentially a versatile humanoid robot. Enabling such a robot system to execute general human tasks poses a challenge due to the vast array of potential positions, locations, and states said robots could occupy at any given time in a challenging environment. The multitude of these permutations can be minimized by training the robot system through various methods such as: (i) imitation learning or teleoperation, (ii) supervised learning, (iii) unsupervised learning, (iv) reinforcement learning, (v) inverse reinforcement learning, (vi) regression techniques, or (vii) other established methodologies. To further streamline the vast array of possible positions, locations, and states, reduce manufacturing steps, complexities and costs, minimize components within the robot system, enhance component modularity, and achieve several other advantages that would be apparent to those skilled in the field, two or more components of the end effector can be either: (i) linked, or (ii) fixed to one another. When two or more components are linked or fused, movement of one component results in movement in another component. In contrast to conventional end effectors that fuse the medial and distal assemblies to one another, the disclosed thumb assembly allows for: (i) some independent movement of the medial assembly in relation to the distal assembly, and (ii) certain movement of the medial assembly to result in movement of the distal assembly. Such linking allows the thumb assembly allows it to become underactuated, that is, to retain its ability to flex, curl, or rotate around an object while eliminating the necessity for multiple actuators, motors, or effectors for each thumb assembly. Indeed, the disclosed thumb assembly includes only two motor that drives linkages that provide four degrees of freedom DoF. Thus, the end effector has a total of 16 DoF.

While the disclosed thumb assembly in the end effector 10 utilize a single biasing member (e.g., spring), said thumb assembly utilize a direct drive linkage system in order to eliminate the need to use more than one (e.g., multiple) biasing members (e.g., springs) to force the thumb assembly to remain in a predefined position (e.g., open, uncurled, or neutral). Eliminating the need to use multiple biasing members (e.g., springs) to force the thumb assembly 40 to remain open, uncurled, or in a neutral position. Eliminating the use of multiple biasing members for this purpose provides a significant benefit over conventional end effectors because it: (i) removes the need for the motor assembly to overcome a significant biasing force applied by the biasing members to move the thumb assembly, (ii) increases durability, robustness, and life of the end effector due to the fact that said biasing members can rapidly degrade over time, and (iii) makes the control of the digit assembly simpler as the same force is exerted on the housing frame regardless of which direction (i.e., towards the palm or away from the palm) the digit assembly is moving.

Additionally, the disclosed direct drive linkages include components that nest within one another. The use of nesting components is beneficial over a conventional thumb assembly of end effectors because each link is supported by at least one coupling point on either side of a plane extending through the center of the thumb assembly. In other words, each link in the disclosed finger assembly is coupled on multiple sides, not simply coupled on a single side, which increases the durability of the assembly.

The disclosed thumb assembly in the end effector 10 has a proximal assembly that includes: (i) one component that is directly tied to the movement of the motor, and (ii) one component that is not directly tied to the movement of the motor. For example, the movement of the proximal drive link assembly is directly tied to the movement of the motor, while the proximal housing is not directly tied to the movement of the motor. In fact, the proximal assembly utilizes bearings to allow slippage between the motor and at least the proximal housing when an extent of the proximal assembly has come into contact with a resistance point/surface. This configuration is beneficial over conventional end effectors because it allows a single motor to drive the thumb assembly 40, while allowing specific components within the proximal assembly to stop moving even though the motor still drives other components.

Unlike conventional end effectors with thumb assemblies, the end effector 10 disclosed in this Application includes two motors that are positioned within the palm of the end effector 10, wherein: (i) both motor are designed to interact with a single gear assembly, (ii) the first motor is configured to control the digit assemblies adduction/abduction and the second motor is configured to control the digit assemblies flexion/extension. This configuration allows for a compact package that is capable of controlling multiple movements of the thumb assembly. Other benefits of the movement assembly are disclosed below in greater detail and/or may be obvious to one of skill in the art.

While the structural configuration of the thumb assembly will be discussed in greater detail below, it should be understood that the thumb assembly is configured to be a separate component of the end effector that is modular and removably coupled to a frame of the end effector. As such, the thumb assembly is swappable (and in certain embodiments hot-swappable) with another thumb assembly. The separate, modular, and swappable nature of the thumb assembly means that: (i) pulleys, articulation cables, pneumatic or hydraulic mechanisms may be omitted from the end effector, and (ii) components of the end effector are not located in the wrist, lower arm, or generally outside of the thumb assembly. In other words, a majority of the motor, PCBs, encoders and other electronic components needed to move the thumb assembly are fully contained within said thumb assembly and are not distributed throughout the end effector 10 and/or robot. This entire containment aspect is desirable because it increases serviceability and thus decreases the cost of ownership and operation of the robot. In other embodiments, all components (e.g., motor, PCBs, encoders, etc.) needed to move the thumb assembly may be fully contained within said thumb assembly. In other words, the palm of the end effector 10 and/or other components of the robot may not contain any components needed to move the thumb assembly.

Finally, the end effector 10 disclosed herein may lack several components typically found in conventional end effectors. For example, the disclosed end effector 10 (including each finger assembly and the thumb assembly) lacks pulleys, articulation cables, more than two motors used in connection with the thumb assembly, force sensors, and other components typically found in conventional end effectors. Eliminating these components reduces cost and complexity, while increasing modularity, serviceability, and durability. Other benefits of the disclosed end effector 10 and its various assemblies and components should be apparent to one of skill in the art based on this disclosure and the accompanying figures.

### B. End Effector

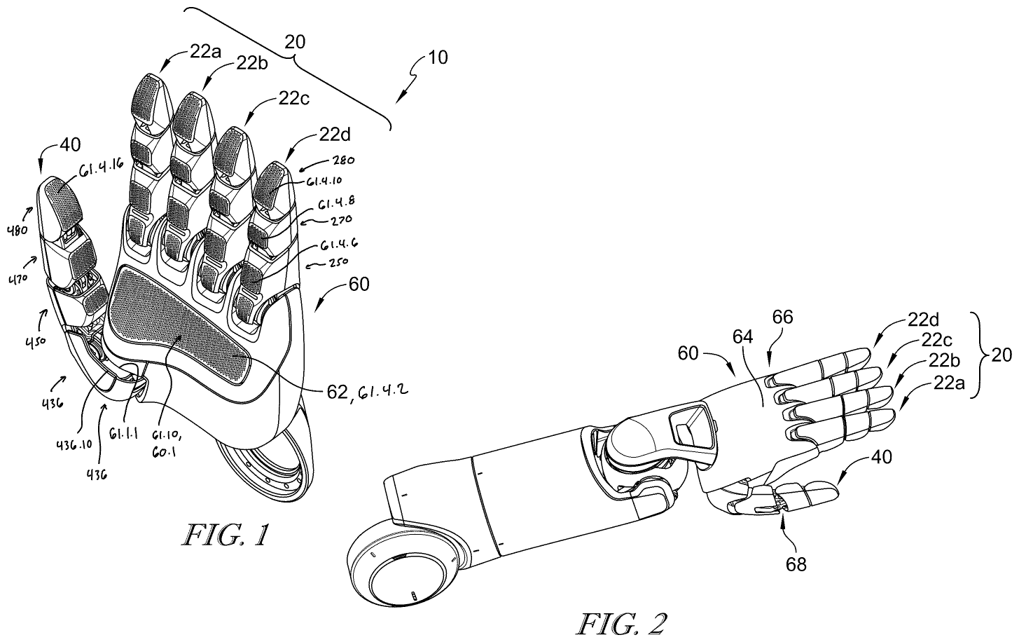

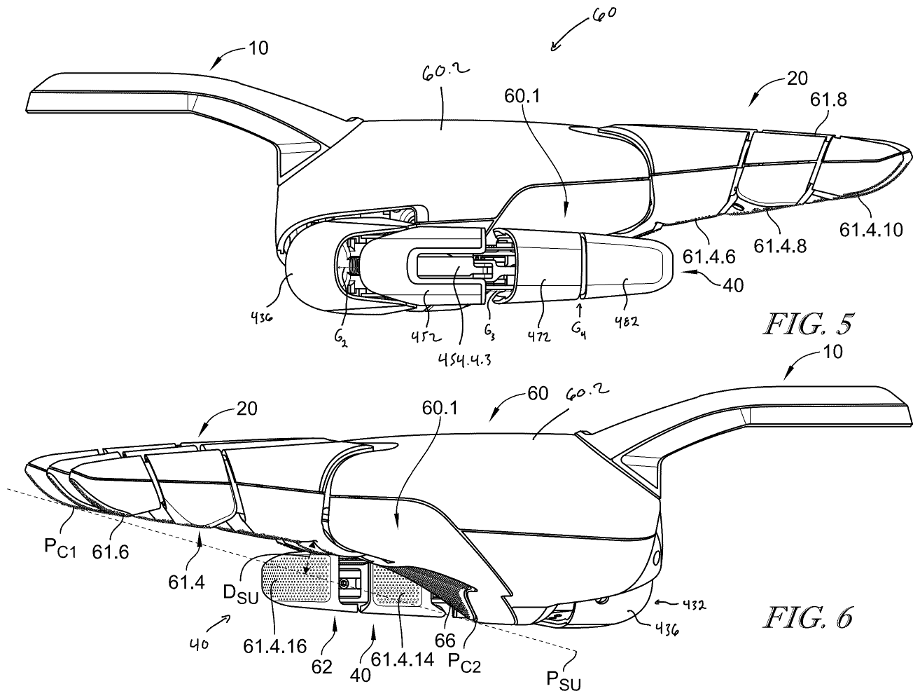

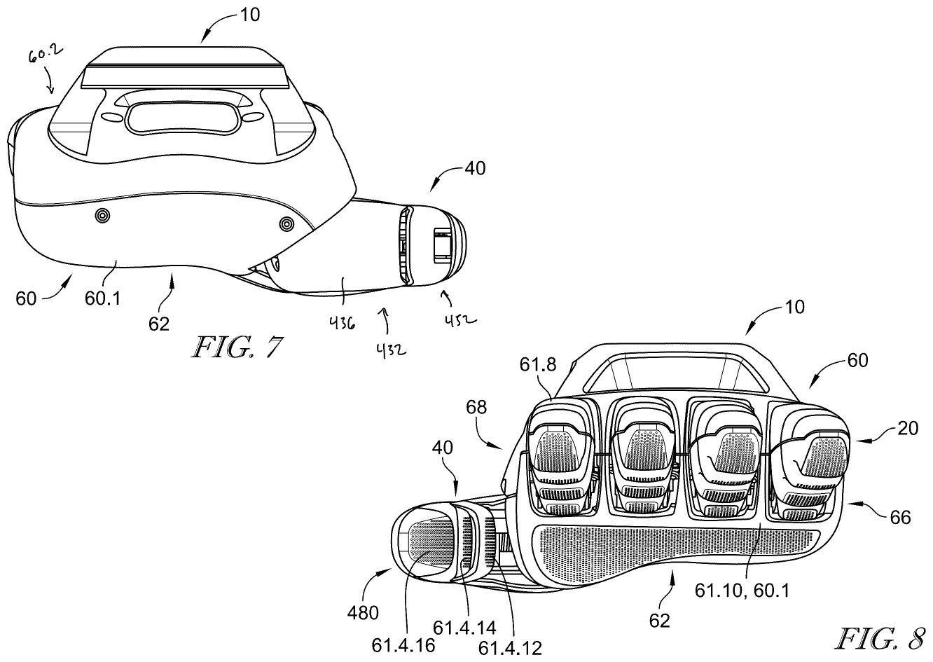

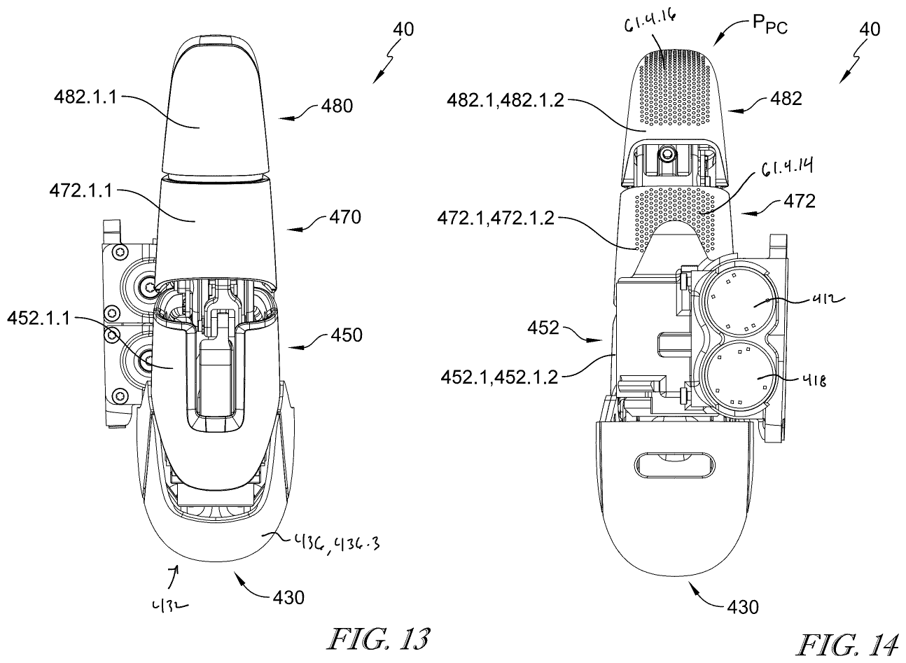

With reference, for example, to FIGS. 1-18, the end effector 10 includes: (i) a set of finger assemblies 20 with at least one finger assembly 22n (as shown, the set of finger assemblies 20 includes four finger assemblies 22a, 22b, 22c, 22d), (ii) a thumb assembly 40, (iii) a housing assembly 60, and (iv) electronics 80 that are configured to control each finger assembly 22n of the set of finger assemblies 20 and the thumb assembly 40. As shown in the Figures, the housing assembly 60 is configured to: (i) encase and protect the electronics 80, and (ii) securely locate each of the finger assemblies 22a-22d and the thumb assembly 40 in a particular position relative to each other and the housing assembly 60. The housing assembly 60 may be covered by a glove and can have: (i) a palm region 62, (ii) a back region 64, (iii) left and right sides 66, 68, and (iv) a front region 70. Additionally and as discussed in great detail below, said housing assembly 60 is comprised of: (i) a palm housing 60.1, (ii) a back housing 60.2, (iii) a base joint or carpometacarpal joint housing assembly 436, a proximal housing assembly 452, a medial housing assembly 472, and a distal housing assembly 482. It should be understood that the housing assembly 60 may include additional or fewer components or assemblies. It should further be understood in alternative embodiments, the end effector 10 may include a single finger, two fingers, three fingers, or five fingers. In a further alternative, the end effector 10 may not include a single finger assembly 22a-22d, but instead may include a plurality of thumb assemblies.

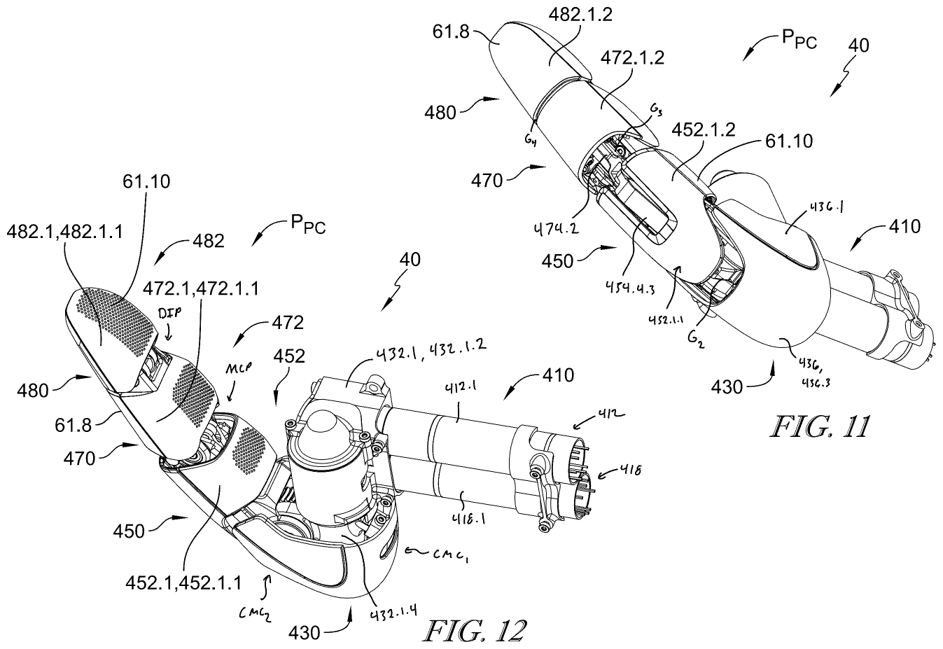

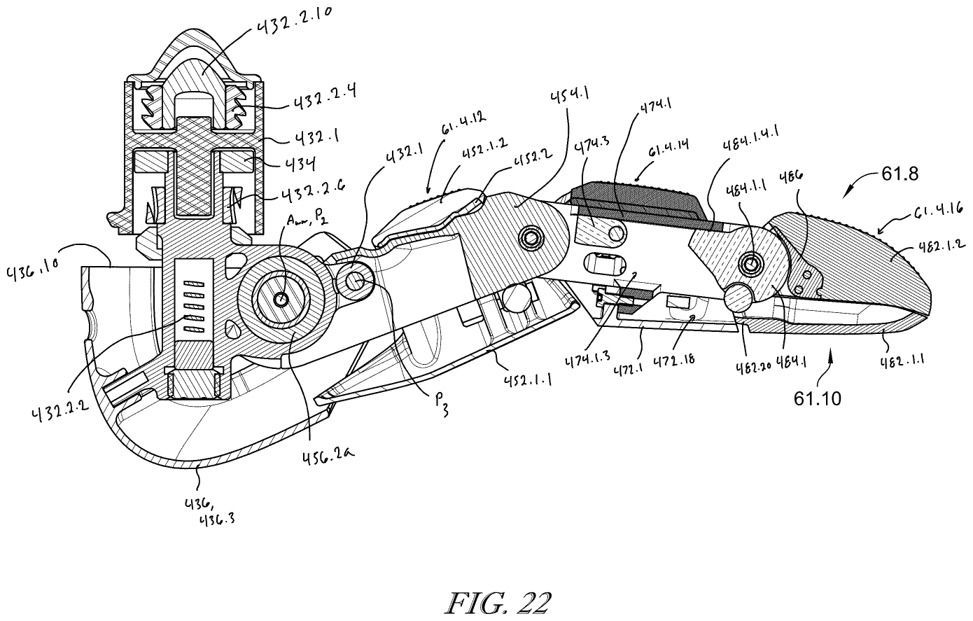

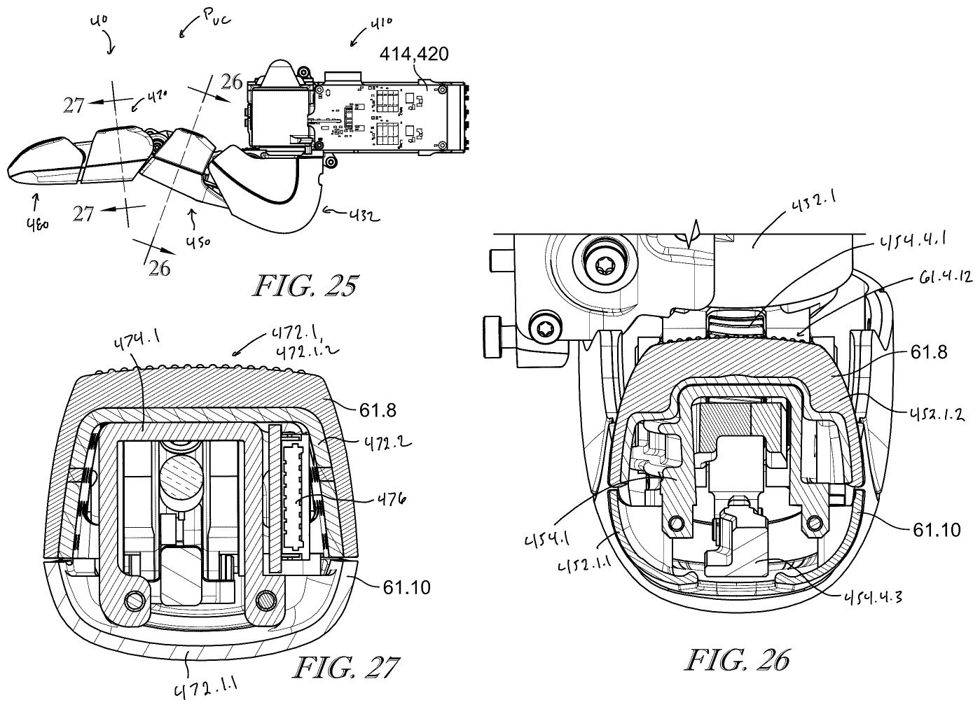

As shown in FIGS. 12-26, said housing assembly 60 may include multiple components that are made from different materials, may include multiple layers that are made from different materials, and/or may be made from materials that have different rigidities, densities, C/D ratios, durabilities, fabrication methods, and the alike. For example, the end effector frame 61.2 may be made from a first material with a first rigidity, the exterior top housing 61.8 may be made from a second material with a second rigidity, the interior bottom housing 61.10 may be made from a third material with a third rigidity, and wherein said first rigidity is greater than the second rigidity, and the second rigidity is greater than the third rigidity. For example, the end effector frame 61.2 may be made from rigid metal, the exterior top housing 61.8 may be made from rigid plastic, and the interior bottom housing 61.10 may be made from deformable silicon or soft plastic. It should be understood that these are examples of possible materials and configurations and are not intended to be limiting in any manner. In other embodiments, the exterior or skin of the end effector 10 may be as rigid as the internal link assemblies of the housing assembly 60, wherein the housing and the internal link assemblies are both made from a durable and hard plastic. In further embodiments, the exterior or skin of the end effector 10 may be more rigid than the internal link assemblies of the housing assembly 60.

As described above in an alternative embodiment and as shown in FIG. 29, the interior bottom housing 61.10 may include a plurality of layers 61.20, wherein a first interior layer 61.20.2 that is made from a first material having a first rigidity and a second exterior layer 61.20.4 that is made from a second material having a second rigidity. In this example, the first material may be rigid plastic or metal, while the second material is deformable silicon, soft plastic, or deformable textile or fabric. As such, the thumb assembly 40 is configured to be covered by a textile covering (e.g., glove). It should be understood that the second material may be replaceable (i.e., removably coupled) or may not be permanently affixed to the end effector 10. This design may allow for a softer material to be used on the palm surface 61.2.2 of the end effector 10 that is designed to be less durable, and thus needs to be replaced when damaged or at pre-defined intervals (e.g., 1 week, 1 month, 6 months, 1 year, 5 years, or any interval between 1 day and 10 years). In other examples, the plurality of layers 61.20 may have three layers, wherein the first layer 61.20.2 is rigid to provide protection for the internal components, a second layer 61.20.4 is less rigid than the first layer 61.20.2 to enable the end effector 10 to pick up delicate items, and a third layer 61.20.6 that is designed to protect the second layer 61.20.4. In this example, the first layer 61.20.2 may be made from durable plastic or metal, the second layer 61.20.4 may be made from deformable thermoplastic, and the third layer 61.20.6 may be made from textile, cloth, or fabric (e.g., glove). Said third layer 61.20.6 may be replaceable at pre-determined intervals and may be coupled to the end effector 10 using snaps, buttons, removable fasteners, push-pins, or any other type of mechanical coupling mechanism that is removably or permanent. In a final example, the plurality of layers 61.20 may have any number of layers, wherein layer 61.20.8 represents layer number four through the nth layer.

Examples of materials that may be used in the end effector 10 include, but are not limited to, metal (e.g., aluminum, stainless steel, titanium alloys, magnesium alloys, copper alloys, nickel-based alloys), carbon fiber composites, glass fiber composites, basalt fiber composites, Kevlar® composites, polycarbonate, acrylic (PMMA), acrylonitrile butadiene styrene (ABS), nylon, polyoxymethylene (POM), polyether ether ketone (PEEK), polyetherimide (PEI), polyphenylene sulfide (PPS), polytetrafluoroethylene (PTFE), polypropylene (PP), polyethylene (PE), high-density polyethylene (HDPE), thermoplastic polyurethane (TPU), polyamide-imide (PAI), other plastic (e.g., may include a polymer composition), rubber (e.g., nitrile rubber, EPDM), silicone, polyurethane elastomers, ceramic materials (e.g., alumina, zirconia), a combination of these materials, and/or any other suitable material. Additionally, the housing assembly 60 and other components of the end effector 10 may be injection molded, 3D printed, subtractive manufactured, or created using any other known method of manufacturing.

FIG. 6 shows a finger side view of the end effector 10, wherein a surface plane P_{SU} has been added to illustrate the contact points between the palm side of the housing assembly 60 and a flat or planar surface. For example, the surface plane P_{SU} may represent the outermost surface formed by a tote designed to carry parts or components of a car. As shown in this Figure, two main contact points are formed between said surface and the end effector 10, wherein a first contact point P_{C1} is formed near the tip of the middle finger 22b and a second contact point P_{C1} is formed near the base of the palm. The greatest distance D_{SU} between said surface plane P_{SU} and the housing assembly 60 formed near the knuckle assembly is less than 10 mm, preferably less than 5 mm, and most preferably less than 1 mm. As shown in this Figure, it is beneficial to have the palm or inner surface of the end effector 10 flat or nearly flat to help maximize the contact surface area between the end effector 10 and the surface plane P_{SU}, as this design simplifies approach angles, and reduces the need to perform complex grasping movers with the wrist.

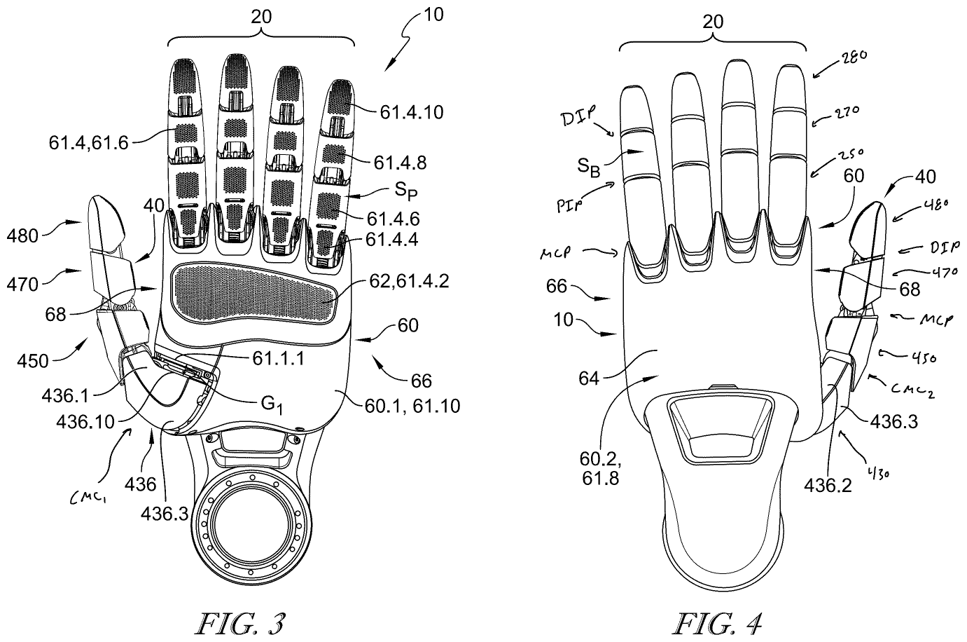

As best shown in FIGS. 3-4, 9, and 11, the housing assembly 60 includes a substantially smooth top or back surface S_{B} and a rough or non-smooth bottom or palm surface S_{P}. The rough or non-smooth palm surface S_{P} is created by adding a plurality of contact areas 61.4. In other words, the entire palm surface S_{P} is not rough or non-smooth. Said plurality of contact areas 61.4 is designed to increase the end effector's 10 to grasp and hold an object. Specifically, the plurality of contact areas 61.4 are comprised of distinct regions 61.4.2-61.4.16 that include multiple bumps or projections 61.6. Said regions 61.4.2-61.4.16 are formed on the palm, each assembly (i.e., proximal, medial, and distal) contained within each thumb assembly 40, and each assembly (i.e., proximal, medial, and distal) contained within the thumb assembly 40. For example, the palm 62 may have one large contact region 61.4.2, the proximal assemblies of the fingers 22a-22d may include two contact regions 61.4.4, 61.4.6, the medial assemblies of the fingers 22a-22d may include one contact region 61.4.8, the distal assemblies of the fingers 22a-22d may also include one contact region 61.4.10, the proximal 450 assembly of the thumb 40 may include one contact region 61.4.12, the medial 470 assembly of the thumb 40 may include one contact region 61.4.14, the distal 480 assembly of the thumb 40 may also include one contact region 61.4.16. The height of the bumps or projections 61.6 may be 0.01 mm to 2 mm, and preferably between 0.25 mm and 0.75 mm. It should be understood that in other embodiments, the plurality of contact areas 61.4 may be omitted, the number of regions contained in the plurality of contact areas 61.4 may be increased (e.g., between 18 and 100) or decreased (e.g., between 1 and 16), the number of bumps or projections 61.6 within each region may be increased or decreased, and/or the height of the bumps or projections 61.6 may be increased or decreased.

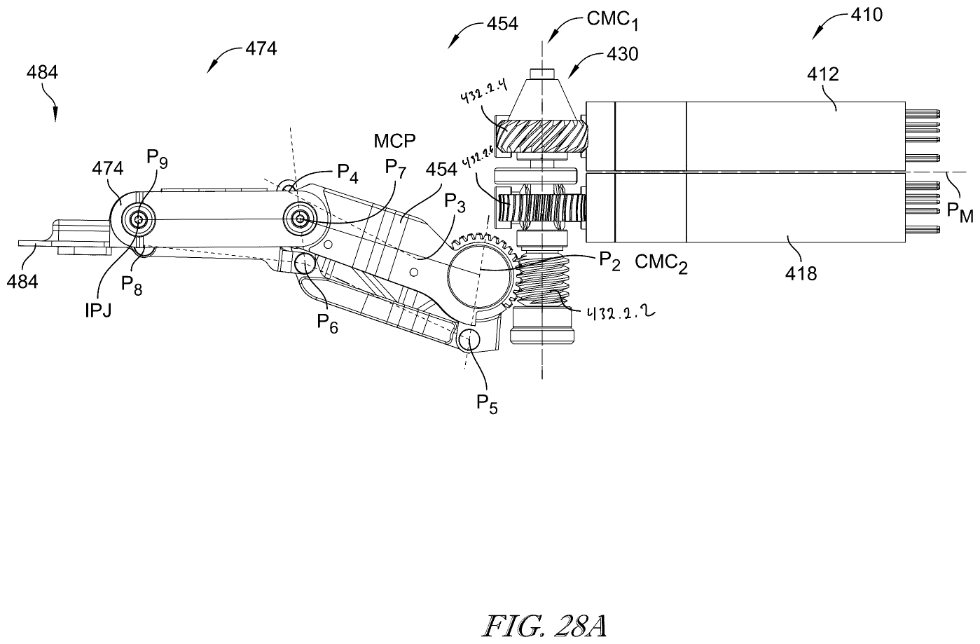

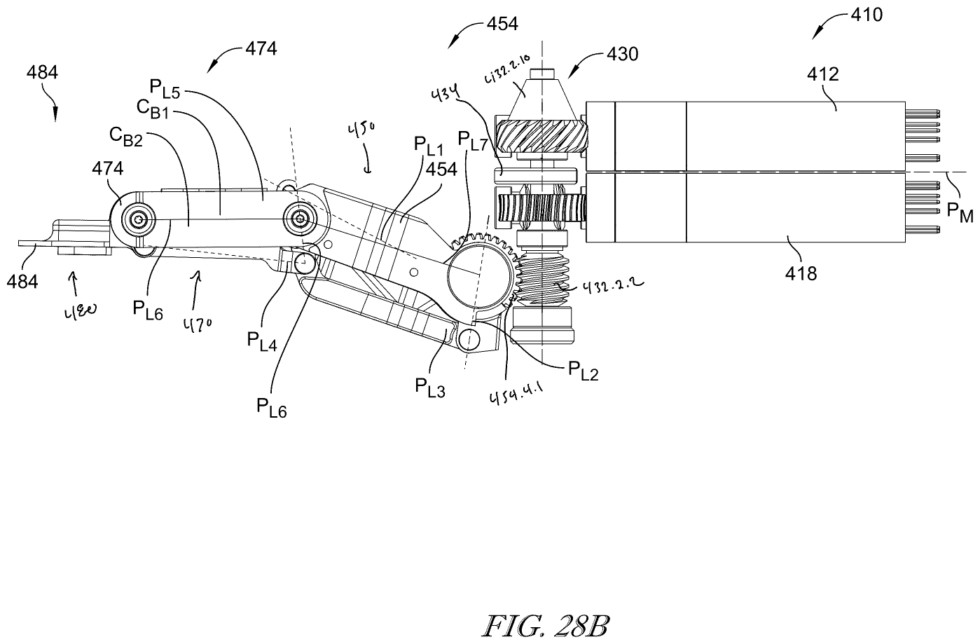

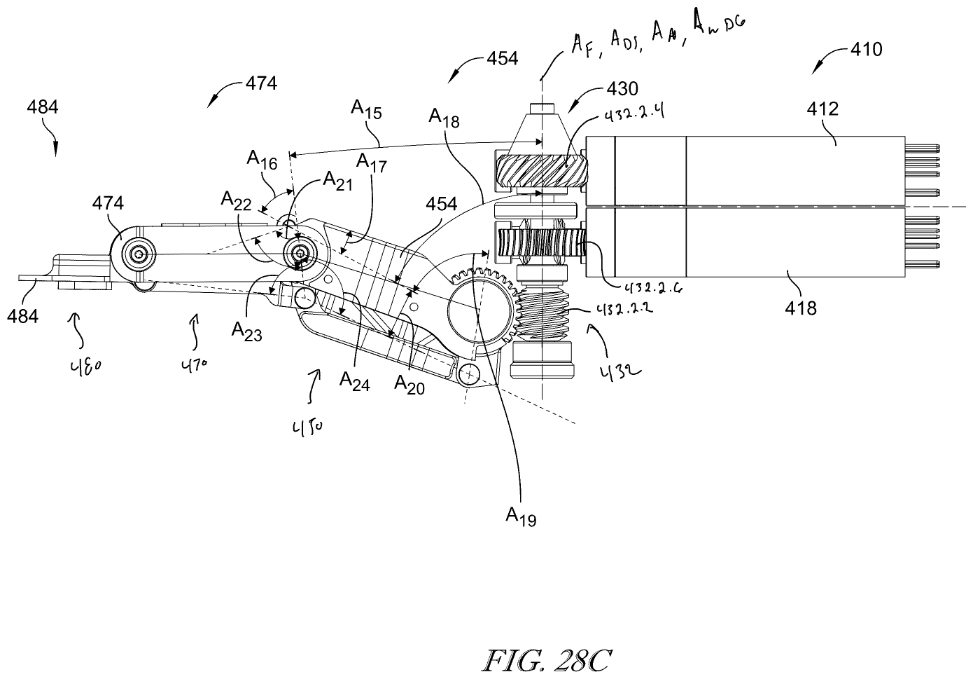

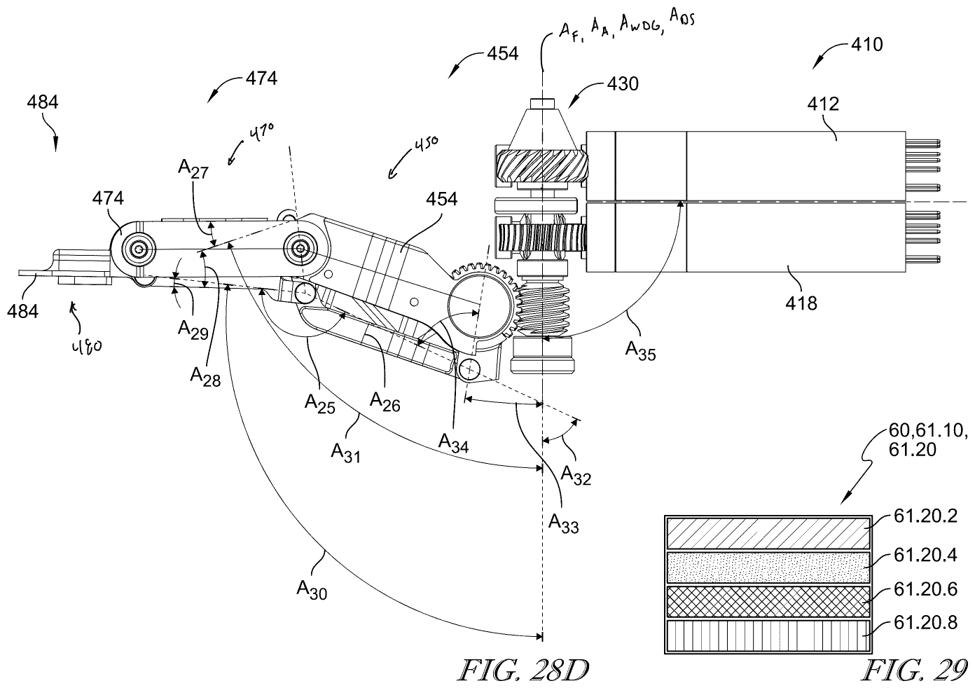

As best shown in FIGS. 27 and 28, the housing assembly 60 of the thumb assembly 40 and specifically the outer surfaces 61.8.2, 61.10.2 of the exterior top housing 61.8 and the interior bottom housing 61.10 have a cross-sectional shape that is similar to an obround or a discorectangle. This cross-sectional shape is desirable because it provides rounded edges that help the thumb assembly 40 avoid contact with other objects, and substantially flat surfaces that help the thumb assembly 40 maximize contact with the object it is grasping. In comparison to the finger assemblies 22a-22d, the thumb assembly 40 has: (i) a larger contact surface that has a substantially flat configuration (except for the bumps or projections) 61.6, (ii) its width is closer to the height (or stated another way, the thumb is more of a round shape and the finger is more of an oval shape). It should be understood that in other embodiments, the comparison between the thumb assembly 40 and the finger assemblies 22a-22d may be switched, altered, or changed in any manner known in the art. However, switching the configurations of the thumb assembly 40 and the finger assemblies 22a-22d may not be desirable because it would reduce the contact surface area of the thumb; thus, making it less useful.

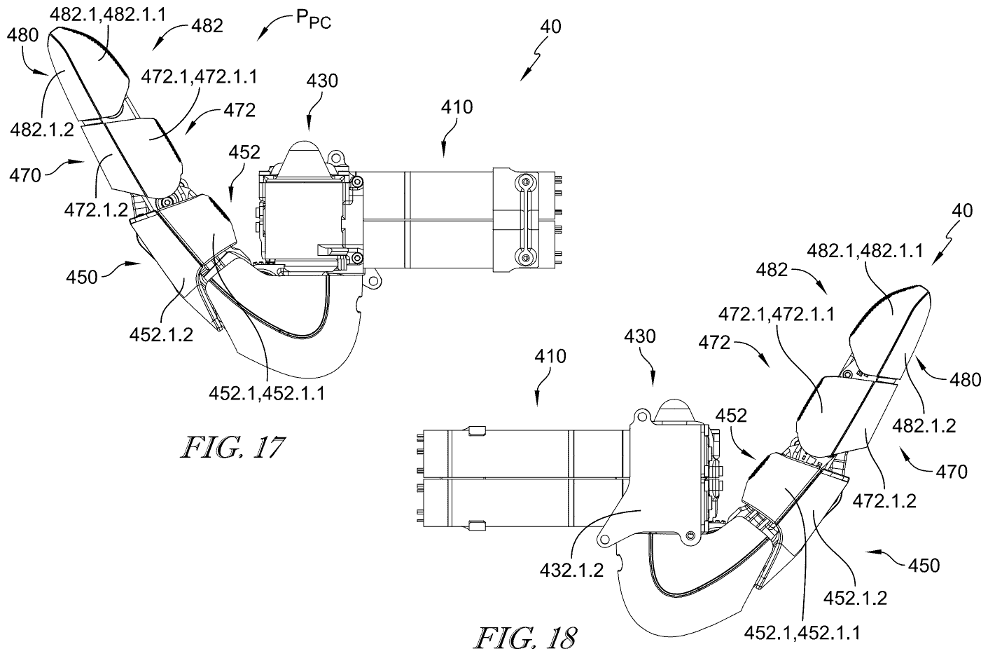

With reference, for example, to FIGS. 1-13, the end effector 10 comprises a thumb assembly 40. The thumb assembly 40 is removably connected to the palm surface 61.2.2 of the end effector frame 61.2 using elongated fasteners and is replaceable (and in some embodiments, it may be hot-swappable with a replacement thumb assembly 40). The replaceable aspect of the thumb assembly 40 eliminates the need for various structural elements, such as synthetic tendons, mechanical or articulation cables, pulleys, pneumatic or hydraulic cables, and other components that extend from the lower arm or wrist to the medial or distal sections of the thumb assembly 40. This configuration ensures that at least a majority, if not all, of the components such as linkages, motors, PCBs, encoders, and other elements required to actuate each thumb assembly 40 are self-contained within the palm region 62 and/or the thumb assembly 40 and are not spread throughout the robot system. This setup is advantageous as it enhances serviceability, consequently reducing the overall cost of ownership and usage. As shown in FIG. 18, the thumb motor plane P_{TM} is offset by an angle gamma γ from line L₁, wherein: (i) line L₁ is perpendicular to the sagittal plane P_{S} or the middle finger plane P_{22b} and intersects with the center point of the knuckle assembly of the middle finger 22b, and (ii) the angle gamma γ is usually at least 1 degree, preferably between 2 degrees and 12 degrees, and most preferably between 4 degrees and 6 degrees, and likely less than 16 degrees. In light of this configuration, the first and second motor shaft axes are also offset by an angle gamma γ from line L₁, wherein: (i) line L₁ is perpendicular to the sagittal plane P_{S} or the middle finger plane P_{22b} and intersects with the center point of the knuckle assembly of the middle finger 22b, and (ii) the angle gamma γ is usually at least 1 degree, preferably between 2 degrees and 12 degrees, and most preferably between 4 degrees and 6 degrees, and likely less than 16 degrees. Thus, the first and second motor shaft axes are non-parallel with the sagittal plane.

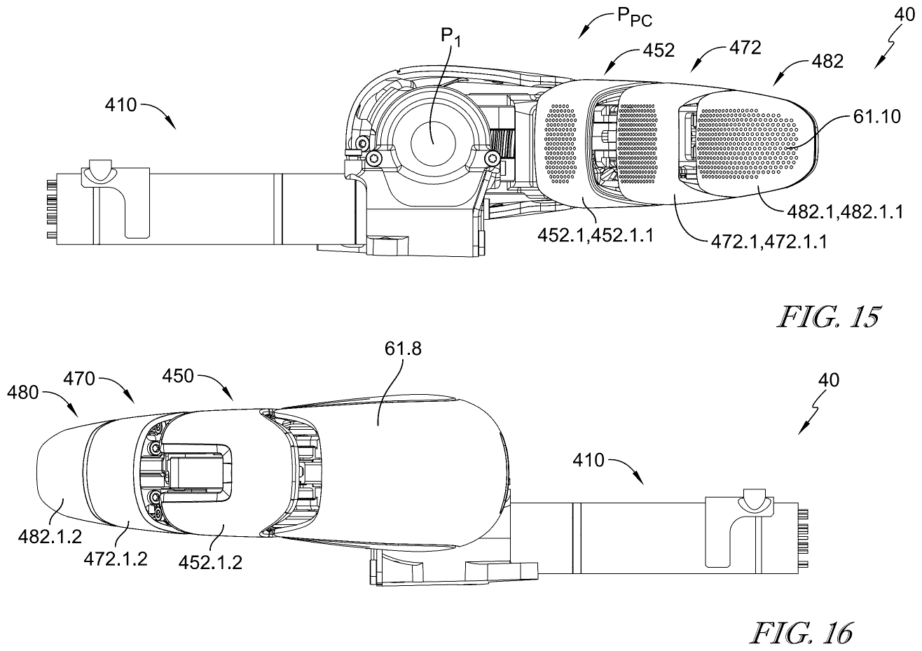

With reference, for example, to FIGS. 15-25, the end effector 10 comprises four finger assemblies 22a-22d that are removably connected to the back surface 61.2.4 of the end effector frame 61.2 using elongated fasteners and are configured to operate independent of one another. As shown in the figures, each finger assembly 22a-22d of the plurality of finger assemblies 22a-22d includes a single finger motor assembly 210 and a metacarpophalangeal joint MCM, a proximal finger interphalangeal joint PIP, and a distal finger interphalangeal joint DIP. Additionally, each finger assembly 22a-22d includes a proximal assembly 250, a medial assembly 270, and a distal assembly 280. In some embodiments, the end effector 10 may include more or fewer than four finger assemblies. The finger assemblies 22a-22d may be configured identically, which may allow for reducing the number of distinct components used to manufacture the finger assemblies 22a-22d, and may enhance modularity, potentially reducing expense. The modular nature of the finger assemblies 22a-22d may enable them to be easily replaceable and may enable hot-swapping of the finger assemblies in some cases. The modular and replaceable aspect of the finger assemblies 22a-22d may eliminate the use of various structural elements, such as synthetic tendons or articulation cables, pulleys, pneumatic or hydraulic cables, and other components that extend from the lower arm or wrist to the medial or distal sections of the finger assemblies 20. This configuration may allow components such as linkages, motors, PCBs, encoders, and other elements used to actuate each finger assembly 22a-22d to be self-contained within the palm and/or within each finger assembly 22a-22d and not spread throughout the robot system. This setup may enhance serviceability, potentially reducing the overall cost of ownership and usage.

In other embodiments, it should be understood that finger assemblies 22a-22d may not be identical. Instead, there may be two pairs of finger assemblies, wherein the finger assemblies contained in said pairs of finger assemblies are identical. In other words, there may be two unique types of finger assemblies contained in said end effector 10, wherein there are two finger assemblies of a first type and two finger assemblies of a second type. For example, the pointer finger 22a and the small finger 22d may be the first type, while the middle finger 22b and the ring finger 22c may be the second type (while the middle and ring 22b, 22c are different from the pointer and small 22a, 22d). In another example, the pointer finger 22a and the middle finger 22b may be the first type, while the ring finger 22c and the small finger 22d may be the second type (while the ring and small 22c, 22d are different from the pointer and middle 22a, 22b). In an additional embodiment, there may be two unique types of finger assemblies contained in said end effector 10, wherein there are three finger assemblies of a first type and one finger assembly of a second type. For example, the pointer, middle, and ring fingers 22a-22c may be of the first type and the small finger 22d may be of the second type. In another embodiment, there may be three unique types of finger assemblies contained in said end effector 10, wherein there are two finger assemblies of a first type, one finger assembly of a second type, and one finger assembly of a third type. For example, the middle and ring fingers 22b, 22c may be the first type, the pointer finger 22a may be of the second type to allow for abduction, and the small finger may be of the third type 22d due to its size. In a further embodiment, all finger assemblies 22a-22d may be unique. Finally, it should be understood that other combinations of finger assembly types are contemplated by this application, and the above examples are not intended to be limiting.

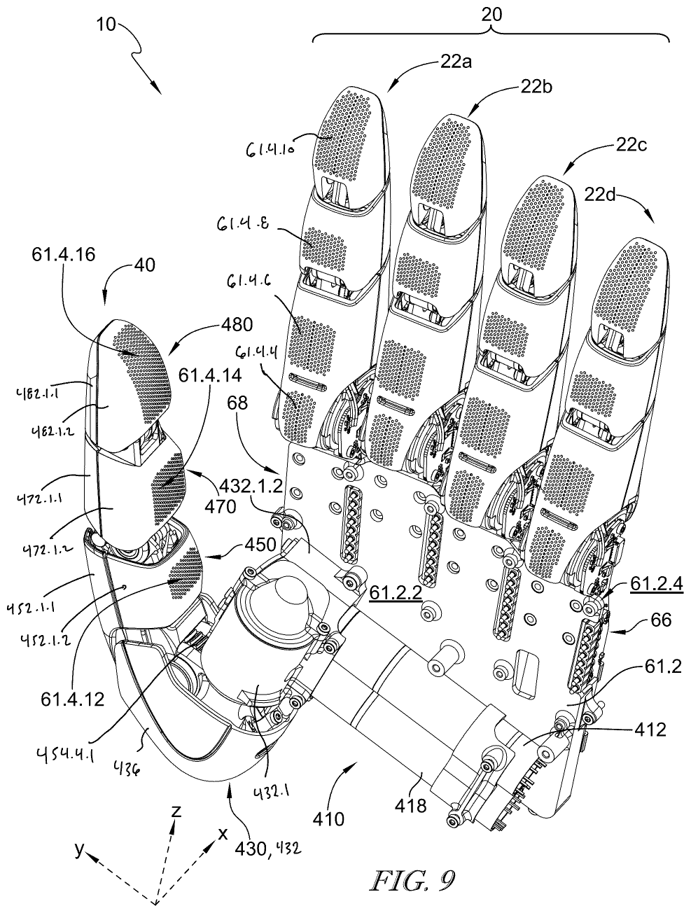

With reference, for example, to FIGS. 9-10, each finger assembly 22a-22d may be connected to the back surface 61.2.4 of the end effector frame 61.2. Thus, the overall location of the figure assembly 22a-22d cannot move in the Y-Z plane. Also, the finger assemblies 22a-22d may be connected to the end effector frame 61.2 in a manner that ensures that the tips are not aligned with one another. In other words, each finger assembly 22a-22d is: (i) angularly offset and horizontally offset to at least one other finger assembly 22a-22d in the X-Y plane, and (ii) vertically offset to at least one other finger assembly in the X-Z plane. This configuration of finger assembly 22a-22d enables each finger assembly 22a-22d of the four finger assemblies 22a-22d to be angularly offset along the X-Y plane and within the Y-Z plane with respect to every other finger assembly 22a-22d of the four finger assemblies 22a-22d. The fixed position of the finger assemblies 22a-22d may reduce the complexities of building, using, maintaining, and repairing the end effector 10.

As shown, the middle or third finger assembly 22b is positioned such that its sagittal plane P_{S} is orientated substantially vertically on the page. Based on the position of the middle or third finger assembly 22b, it can be seen that the center (i.e., C₂₂ₐ, C_{22c}, C_{22d}) of a knuckle assembly 230 of each of the pointer, ring, and small fingers 22a, 22c, and 22d are positioned: (i) slightly rearward from the line L₁ and the center C_{22b} of the knuckle assembly of the middle finger 22b (see FIG. 12), and (ii) are angled relative to the center of the knuckle assembly 230 of the middle finger 22b (see FIG. 10). This configuration also causes the fasteners 61.30a-61.30b that removably connected the finger assemblies 22a-22d at a respective point to the end effector frame 61.2 to be not co-linear. At best, two of the respective point may be co-linear, but all four points are not co-linear. However, all four respective point 61 are aligned in the same Y-Z plane.

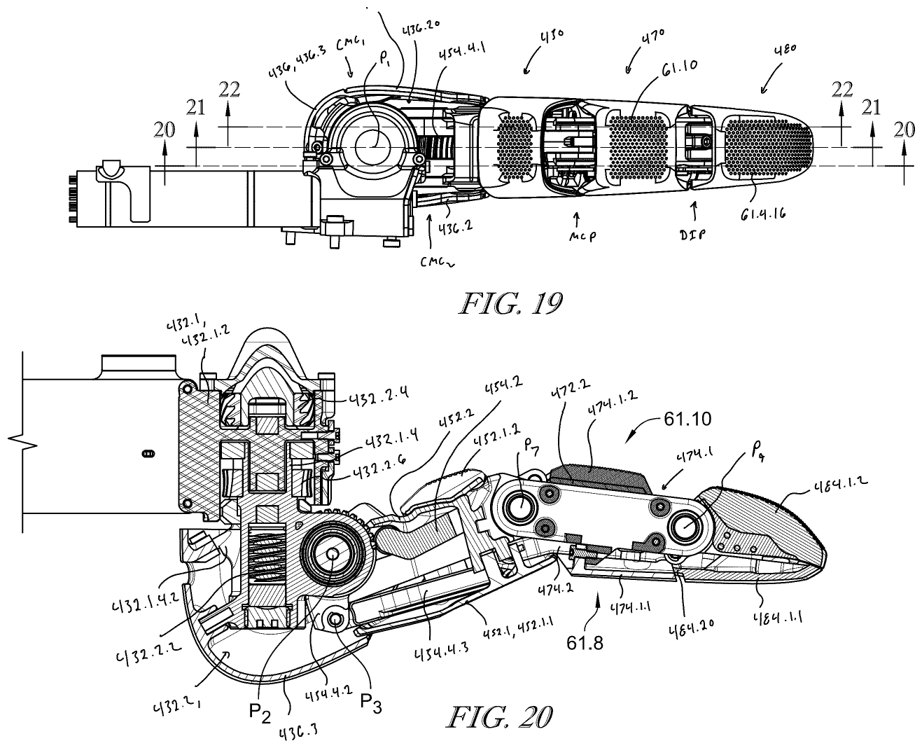

Exemplary positional relationship between components of a thumb assembly 40 is shown in FIG. 20 are listed in Table 1. It should be understood that the dimensions, angles, ratios, and other values that can be derived therefrom that are disclosed in the figures and Tables 1-3 are important to ensure that the end effector 10 can move, grasp objects, and be used in the desired robot system. As such, the structures, features, dimensions, angles, ratios, and other values that can be derived therefrom of non-end effectors for robots and non-linkage based end effectors cannot be simply adopted or implemented into an end effector 10 without careful analysis and verification of the complex realities of designing, testing, manufacturing, training, and using the robot system with an end effector 10. Theoretical designs that attempt to implement such modifications from non-end effectors for robots and non-linkage based end effectors are insufficient (and in some instances, woefully insufficient) because they amount to mere design exercises that are not tethered to the complex realities of successfully designing, testing, manufacturing, training, and using the robot system with an end effector 10.

TABLE 1

| | | | Preferred Lower | Preferred Upper |
|---|---|---|---|---|
| Angle | Lower Bound | Upper Bound | Bound | Bound |
| λ1 | 66.0° | 154.0° | 88.0° | 132.0° |
| λ2 | 30.4° | 70.9° | 40.5° | 60.8° |
| λ3 | 43.6° | 101.8° | 58.2° | 87.3° |
| λ4 | 28.9° | 67.4° | 38.5° | 57.8° |
| λ5 | 43.3° | 101.1° | 57.8° | 86.7° |
| A15 | 3.8° | 8.8° | 5.0° | 7.5° |
| A16 | 33.6° | 78.5° | 44.8° | 67.2° |
| A17 | 5.8° | 13.6° | 7.8° | 11.7° |
| A18 | 37.4° | 87.3° | 49.9° | 74.8° |
| A19 | 42.8° | 99.8° | 57.0° | 85.6° |
| A20 | 1.7° | 3.9° | 2.3° | 3.4° |
| A21 | 80.3° | 187.4° | 107.1° | 160.7° |
| A22 | 46.7° | 109.0° | 62.3° | 93.4° |
| A23 | 46.4° | 108.2° | 61.8° | 92.8° |
| A24 | 72.7° | 169.6° | 96.9° | 145.4° |
| A25 | 96.9° | 226.2° | 129.2° | 193.9° |
| A26 | 3.5° | 8.2° | 4.7° | 7.1° |
| A27 | 10.9° | 25.4° | 14.5° | 21.7° |
| A28 | 14.9° | 34.8° | 19.9° | 29.8° |
| A29 | 2.9° | 6.8° | 3.9° | 5.8° |
| A30 | 57.8° | 135.0° | 77.1° | 115.7° |
| A31 | 42.9° | 100.2° | 57.3° | 85.9° |
| A32 | 39.1° | 91.2° | 52.1° | 78.2° |
| A33 | 5.4° | 12.6° | 7.2° | 10.8° |
| A34 | 44.5° | 103.8° | 59.3° | 88.9° |
| A35 | 54.0° | 126.0° | 72.0° | 108.0° |

TABLE 2

| | |
|---|---|
| P_{S}, P_{22b} | Sagittal Plane or Middle Finger Plane |
| P_{TM} | Thumb Motor Plane |
| P_{SU} | Surface Plane |

TABLE 3

| | |
|---|---|
| P₁ | First Pivot Point-Fixed |
| P₂ | Second Pivot Point-Fixed |
| P₃ | Third Pivot Point-Fixed |
| P₄ | Fourth Pivot Point-Fixed |
| P₅ | Fifth Pivot Point-Not Fixed |
| P₆ | Sixth Pivot Point-Not Fixed |
| P₇ | Seventh Pivot Point-Fixed |
| P₈ | Eighth Pivot Point-Not Fixed |
| P₉ | Ninth Pivot Point-Fixed |

### C. Thumb Assembly

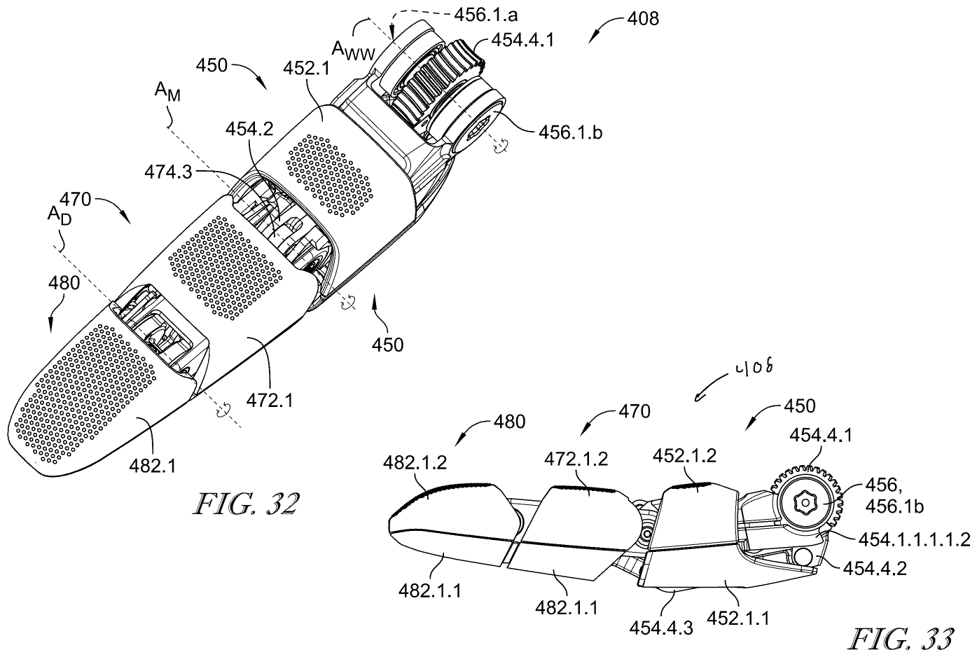

With reference, for example, to FIGS. 3-33, the thumb assembly 40 of the end effector 10 is comprised of: (i) a motor assembly 410, (ii) a base joint assembly 430, (iii) a proximal assembly 450, (iv) a medial assembly 470, and (v) a distal assembly 480. Each of the base joint assembly 430, proximal assembly 450, medial assembly 470, and distal assembly 480 include internal linkages (in combination, internal linkage assembly) that can operate together to move the thumb assembly 40. Each of these assemblies will be discussed in great detail below; however, additional information about said assemblies may be contained within U.S. Provisional Patent Applications Nos. 63/614,499, 63/617,762, 63/561,315, 63/573,226, 63/615,766, 63/620,633, all of which are incorporated herein by reference for any purpose.

a. Motor Assembly

As shown in FIGS. 9, 10, 12, and 25, the motor assembly 410 is configured to be releasably coupled to the palm surface 61.2.2 of the housing end effector frame 61.2, and includes: (i) a first motor 412, (ii) a first controller 414, (iii) a first motor gear 416, (iv) a second motor 418, (iv) a second controller 420, and (v) a second motor gear 422. The first and second motors 412, 418 may be a slotless BLDC motor, a brushed DC motor, a stepper motor, a switched reluctance motor, a permanent magnet synchronous motor, a servo motor, or any other suitable motor. It should be understood that the first and second motors 412, 418 may be the same or may be the same or may have different types, have different torques, transmissions, end stops, or other properties.

As shown in the FIGS. 9-18 and 28A-31B, the motor assembly 410 for the thumb assembly 40 only includes two motors 412, 418; thus, said thumb assembly 40 does not include more than two motors 412, 418. By limiting the number of motors 412, 418 to two, the end effector 10 becomes underactuated. Stated a different way, the thumb assembly 40 includes four joints or 4 degrees of freedom (DoF), wherein each of the four joints or DoFs are controlled by two motors 412, 418. Broken down even further, the first motor 412 is associated with the 3 DoF of the digit assembly, while the second motor 418 is associated with 1 DoF of the base joint assembly 430. This not only simplifies manufacturing, increases durability, enables the thumb assembly 40 to be modular, but also reduces cost and complexity of control.

The motor assembly 410 is a part of the thumb assembly 40 and is not located in a remote portion of the robot system. While this limits the dimensions of the hand (i.e., how small), it reduces linkages, increases modularity, reduces parts, increases accessibility into the working environment and increases the reliability of the thumb assembly 40. Finally, the first controller 414 is designed to control the movements of the thumb assembly 40 and may include the above described electronic controls to limit the rotation and/or movement of the thumb assembly 40.

i. First Motor

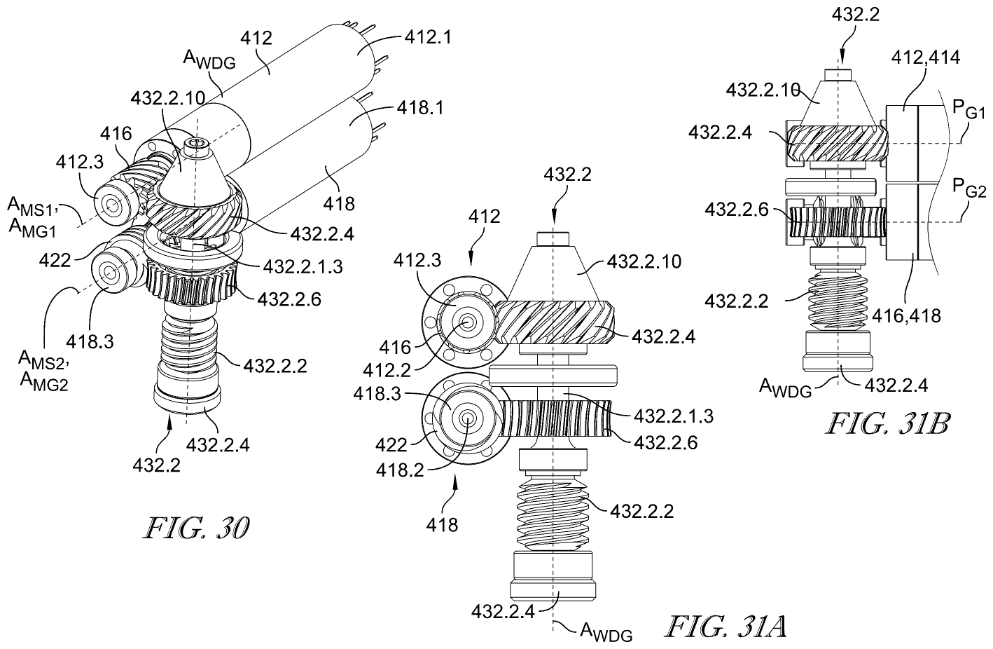

As shown in FIGS. 30-31B, the first motor 412 includes: (i) internal components (not shown), (ii) a digit or first motor housing 412.1, (iii) a digit or first motor shaft 412.2, (iv) a motor gear bearing 412.3. The internal components of the first motor 412 are designed to rotate the first motor shaft 412.2 about a first motor shaft axis A_{MS1}. To help ensure that the first motor shaft 412.2 rotates about the first motor shaft axis A_{MS1} at the desired speed, the internal components of the first motor 412 may include a transmission, gear reduction, or other component. In addition to altering the speed of the first motor shaft 412.2, the transmission, gear reduction, or other component may prevent the first motor shaft 412.2 from making full revolutions (i.e., 365 degrees) around the first motor shaft axis A_{MS1}. In some cases, it may be beneficial to physically limit the rotational movement of the first motor shaft 412.2 (as opposed to electronically limiting said rotation using programming or control methodologies) because it helps ensure that the thumb assembly 40 cannot be over-rotated. However, in other embodiments, the transmission, gear reduction, or other component may not prevent the first motor shaft 412.2 from making full revolutions (i.e., 365 degrees) around the first motor shaft axis A_{MS1}. In this embodiment, electronically limiting said rotation using programming or control methodologies may be used to help ensure that the thumb assembly 40 is not over-rotated. Alternatively, it may be desirable to allow the first motor shaft 412.2 to make full revolutions (i.e., 365 degrees) based on the gearing ratio.

The first motor gear 416 extends past a frontal portion of the first motor housing 412.1 and: (i) includes an extent that is designed to receive the first motor shaft 412.2 to enable said first motor gear 416 to be coupled to the first motor shaft 412.2, and (ii) has helical or screw-like threads. Coupling said first motor gear 416 to the first motor shaft 412.2 enables the internal components of the first motor 412 to rotate the first motor shaft 412.2 around the first motor shaft axis A_{MS1}, wherein said rotation of the first motor shaft 412.2 around the first motor shaft axis A_{MS1} causes the first motor gear 416 to rotate about a first motor gear axis A_{MSG1}. The first motor shaft axis A_{MS1} and the first motor gear axis A_{MSG1} may be parallel, aligned, and coaxial. This coaxial arrangement may be achieved through precise machining and alignment of the motor shaft 412.2 and motor gear 416 during assembly. The motor housing 412.1 may include precision-machined bearing surfaces to support the motor shaft 412.2 and maintain its alignment. Additionally, the motor gear 416 may be manufactured with a precision-bored central opening that closely matches the diameter of the motor shaft 412.2, allowing for a tight, coaxial fit when assembled. In some aspects, additional alignment features such as keyways or splines may be incorporated on the shaft and gear to ensure proper rotational alignment. The use of high-precision bearings at the interface between the motor shaft 412.2 and housing 412.1 may further contribute to maintaining the coaxial relationship between the shaft and gear axes. This configuration may also cause the first motor shaft axis A_{MS1} and the first motor gear axis A_{MSG} to be parallel with (and potentially, coaxial with) the thumb motor plane P_{TM}. In some cases, the first motor shaft axis A_{MS1}, the first motor gear axis A_{MSG1}, and thumb motor plane P_{TM} may not be parallel, aligned, and/or coaxial. Instead, the first motor shaft axis A_{MS1} and the first motor gear axis A_{MSG1} may be perpendicular to one another, while the thumb motor plane P_{TM} may be parallel with the first motor shaft axis A_{MS1}.

As described above, the motor assembly 410 also includes a first motor gear bearing 412.3 that is designed to support the distal, rotating end of the first motor gear 416. In alternative embodiments, the first motor gear bearing 412.3 may be omitted or integrally formed with the first motor gear 416. It may also be understood that in alternative embodiments, the first motor shaft 412.2 and the first motor gear 416 may be integrally formed and/or sealed. As shown in FIGS. 30-31B and discussed below, the first motor gear 416 is designed to be in geared engagement with an extent of the base joint assembly 430, wherein said geared engagement enables the rotation of the first motor gear 416 to cause the thumb assembly to move or curl.

ii. Second Motor

As shown in FIGS. 30-31B, the second motor 418 includes: (i) internal components (not shown), (ii) a second or digit motor housing 418.1, (iii) a second or digit motor shaft 418.2, (iv) a motor gear bearing 418.3. The internal components of the second motor 418 are designed to rotate the second motor shaft 418.2 about a second motor shaft axis A_{MS2}. To help ensure that the second motor shaft 418.2 rotates about the second motor shaft axis A_{MS2} at the desired speed, the internal components of the second motor 418 may include a transmission, gear reduction, or other component. In addition to altering the speed of the second motor shaft 418.2, the transmission, gear reduction, or other component may prevent the second motor shaft 418.2 from making full revolutions (i.e., 365 degrees) around the second motor shaft axis A_{MS2}. In some cases, it may be beneficial to physically limit the rotational movement of the second motor shaft 418.2 (as opposed to electronically limiting said rotation using programming or control methodologies) because it helps ensure that the thumb assembly 40 cannot be over-rotated. However, in other embodiments, the transmission, gear reduction, or other component may not prevent the second motor shaft 418.2 from making full revolutions (i.e., 365 degrees) around the second motor shaft axis A_{MS2}. In this embodiment, electronically limiting said rotation using programming or control methodologies may be used to help ensure that the thumb assembly 40 is not over-rotated. Alternatively, it may be desirable to allow the second motor shaft 418.2 to make full revolutions (i.e., 365 degrees) based on the gearing ratio.

As shown in the Figure, the second motor gear 422 extends past a frontal portion of the second motor housing 418.1 and: (i) includes an extent that is designed to receive the second motor shaft 418.2 to enable said second motor gear 422 to be coupled to the second motor shaft 418.2, and (ii) has helical or screw-like threads. Coupling said second motor gear 422 to the second motor shaft 418.2 enables the internal components of the second motor 418 to rotate the second motor shaft 418.2 around the second motor shaft axis A_{MS2}, wherein said rotation of the second motor shaft 418.2 around the second motor shaft axis A_{MS2} causes the second motor gear 422 to rotate about a second motor gear axis A_{MSG2}. The second motor shaft axis A_{MS2} and the second motor gear axis A_{MSG2} may be parallel, aligned, and coaxial. This coaxial arrangement may be achieved through precise machining and alignment of the motor shaft 418.2 and motor gear 422 during assembly. The motor housing 418.1 may include precision-machined bearing surfaces to support the motor shaft 418.2 and maintain its alignment. Additionally, the motor gear 422 may be manufactured with a precision-bored central opening that closely matches the diameter of the motor shaft 418.2, allowing for a tight, coaxial fit when assembled. In some aspects, additional alignment features such as keyways or splines may be incorporated on the shaft and gear to ensure proper rotational alignment. The use of high-precision bearings at the interface between the motor shaft 418.2 and housing 418.1 may further contribute to maintaining the coaxial relationship between the shaft and gear axes. This configuration also causes the second motor shaft axis A_{MS1} and the second motor gear axis A_{MSG2} to be parallel with (and potentially, coaxial with) the thumb motor plane P_{TM}. In some cases, the second motor shaft axis A_{MS2}, the second motor gear axis A_{MSG2}, and thumb motor plane P_{TM} may not be parallel, aligned, and coaxial. Instead, the second motor shaft axis A_{MS2} and the second motor gear axis A_{MSG} may be perpendicular to one another, while the finger motor plane P_{FM} may be parallel with the second motor shaft axis A_{MS2}.

Also, as shown in FIGS. 30-31B, the first motor shaft axis A_{MS1} is parallel, aligned, and positioned within the first motor gear plane P_{G1}, while the second motor shaft axis A_{MS2} is parallel, aligned, and positioned within the second motor gear plane P_{G2}. The first motor shaft axis A_{MS1} is parallel with the second motor shaft axis A_{MS2}, which causes the first motor gear plane P_{G1} to be parallel with the second motor gear plane P_{G2}. Likewise, the first motor gear axis A_{MSG1} is parallel, aligned, and positioned within the first motor gear plane P_{G1}, while the second motor gear axis A_{MSG2} is parallel, aligned, and positioned within the second motor gear plane P_{G2}. Also, the first motor shaft axis A_{MS1} and the first motor gear axis A_{MSG1} are vertically aligned in a plane that is parallel with the Y-Z plane.

As described above, the motor assembly 410 also includes a second motor gear bearing 418.3 that is designed to support the distal, rotating end of the second motor gear 422. In alternative embodiments, the second motor gear bearing 418.3 may be omitted or integrally formed with the second motor gear 422. It may also be understood that in alternative embodiments, the second motor shaft 418.2 and the second motor gear 422 may be integrally formed and/or sealed. As shown in FIGS. 30-31B and discussed below, the second motor gear 422 is designed to be in geared engagement with an extent of the base joint assembly 430, wherein said geared engagement causes the thumb assembly 40 to move or rotate towards or away from the palm.

b. Base Joint Assembly

The joint assembly 430 is positioned forward of a majority of the motor assembly 410 and is configured to allow the thumb assembly 40 to move from: (i) the open, uncurled, or neutral position to the curled position, and (ii) the open, unrotated, or neutral position to the rotated position. In said curled and rotated position, an acute interior angle is formed between: (i) the right side 68 and an interior surface of the thumb assembly 40, and (ii) the palm 62 and an interior surface of the thumb assembly 40. The joint assembly 430 is best shown in FIGS. 20-24, 28A-28D, 30, and 31A-31B and includes: (i) a carpometacarpal joint assembly 432, (ii) a carpometacarpal electronics 434, and (iii) a carpometacarpal or base joint housing 436.

i. Carpometacarpal Joint Assembly

The carpometacarpal joint assembly 432 includes: (i) a frame 432.1, and (ii) thumb drive assembly 432.2, and wherein said carpometacarpal joint assembly 432 includes a first or vertical carpometacarpal joint assembly CMC₁. The frame 432.1 and the thumb drive assembly 432.2 are complex and important component of the thumb assembly 40, whereby said assemblies 432.1, 432.2 translates the movement of the motor assembly 410 to movements of the base joint assembly 430 and the digit assembly 408. It should be understood that other assemblies, components, sub-components, and/or parts may be added, removed, combined into a fewer number of parts, or separated in additional parts. While some of the positional relationships are set forth below, it should be understood that additional relationships may be derived from the figures (as said assemblies, components, sub-components, and/or parts are shown as proportional to one another).

### 1. Thumb Frame

The thumb frame 432.1 includes two major components, wherein the first component is an upper frame member 432.1.2 and a lower frame member 432.1.4. The upper frame member 432.1.2 is affixed to the end effector frame 61.2 and does not rotate, or move relative to the end effector frame 61.2. The structure and affixed relationship of the upper frame member 432.1.2 and the end effector frame 61.2 enables said upper frame member 432.1.2 to secure the remaining components of the thumb assembly 40 within the end effector 10. As such, the upper frame member 432.1.2 is made from a sufficiently rigid material. Stated another way, the thumb frame 432.1 may be made from any material disclosed herein or known in the art that can achieve the desired task of supporting and securing components of the thumb assembly 40 to the frame 61.2, including the same material as the frame 61.2. In other embodiments, the thumb frame 432.1 may be integrally formed with other components (e.g., palm housing 60.1) and as such be made from the same material as the other component.

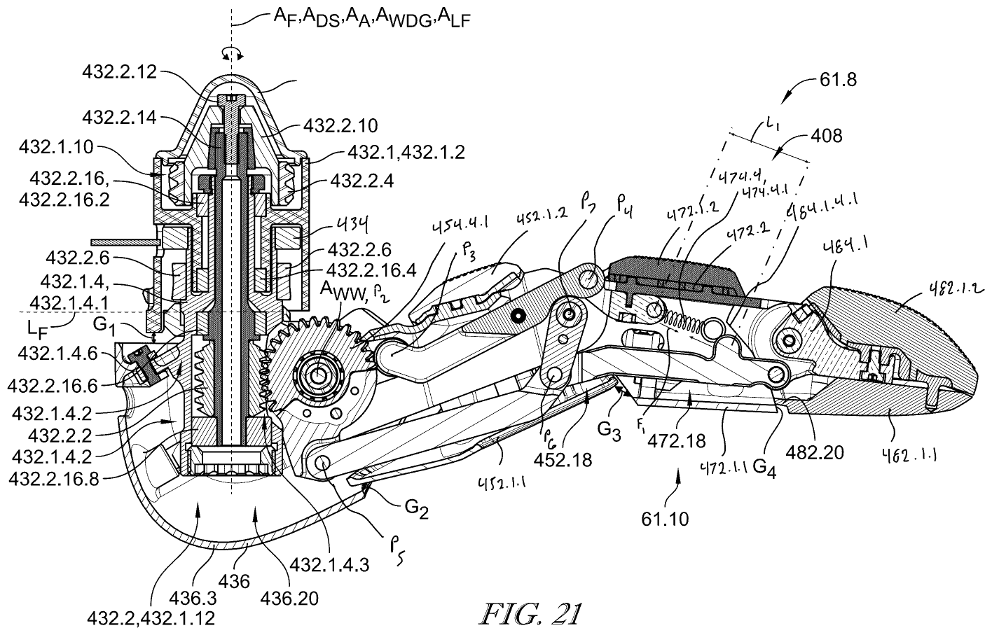

As shown in FIG. 21, the upper frame member 432.1.2 includes an upper opening 432.1.10 and a lower opening 432.1.12. These openings allow for the insertion of the lower frame member 432.1.4 and the thumb drive assembly 432.2. Additionally and as shown in the Figures, the upper frame member 432.1.2 is not simply a tube or cylinder, but instead includes internal walls that are configured to support and allow the lower frame member 432.1.4 and the thumb drive assembly 432.2 to rotate within said upper frame member 432.1.2. It should be understood that the configuration and design of these internal walls may be changed or altered to accompany and/or support the lower frame member 432.1.4 and other components of the thumb assembly 40.

The lower frame member 432.1.4 has a complex geometry that includes a first or upper portion 432.1.4.1 that is positioned above line L_{F} and a lower portion 432.1.4.2 that is positioned below line L_{F}, wherein line L_{F} is co-linear with a lower surface of the upper frame member 432.1.2. Said complex geometry of the lower frame member 432.1.4: (i) allows it to interact with the carpometacarpal electronics 434, (ii) includes the upper portion 432.1.4.1 to rotate within the internal walls of the upper frame member 432.1.2, (iii) provides for carpometacarpal or base joint housing coupling points 432.1.4.6, (iv) has a proximal link aperture 432.1.4.3 formed therein to allow for an interaction between an worm drive gear 432.2.2 and the worm 454.4.1 wheel 336, and (v) is designed to receive a bearing 432.2.16.8. While one embodiment of said lower frame member 432.1.4 is shown in the Figures, it should be understood that other embodiments are contemplated by this disclosure.

### 2. Thumb Drive Assembly

As best shown in FIGS. 20-26, the thumb drive assembly 432.2 is configured to translate the rotational motion from the motor assembly 410 to the carpometacarpal joint assembly 432 and the digit assembly 408. Specifically, the thumb drive assembly 432.2 is in geared engagement with the first and second motor gears 416, 422 and the worm wheel 454.4.1. To do this, the gear assembly 432.2 is comprised of: (i) a worm drive gear 432.2.2, (ii) a flexion gear 432.2.4, (iii) anterposition gear 432.2.6, (iv) a middle, digit adaptor, or flexion gear adaptor 432.2.10, (iii) a flexion gear coupler 432.2.12, (iv) a drive shaft or flexion shaft 432.2.14, and (v) a flexion bearing assembly 432.2.16 that includes a plurality of bearings 432.2.16.2-432.2.8. As discussed above and throughout this application, it should be understood that some of these components may be omitted, modified, replaced, and/or other parts may be added.

The flexion gear 432.2.4 is a toothed gear that is designed to be in geared engagement with the first motor gear 416, such that it rotates in response to the rotation of the motor 412 and generates a first pivot point P₁. Specifically, the rotation of the first or digit motor shaft 412.2 rotates the first motor gear 416, and wherein the rotation of the first motor gear 416 rotates the flexion gear 432.2.4 about a flexion axis A_{F}. While the flexion axis A_{F} does not intersect the first motor shaft axis A_{MS1} or the first motor gear axis A_{MSG1}, said flexion axis A_{F} is perpendicular to both the first motor shaft axis A_{MS1} and the first motor gear axis A_{MSG1}. Based on this configuration, the center of the teeth of the flexion gear 432.2.4, the first motor shaft axis A_{MS1} and the first motor gear axis A_{MSG1} are all positioned within the first motor gear plane P_{G1}. It should be understood that in an alternative embodiment, the flexion axis A_{F} may be parallel with the first motor shaft axis A_{MS1} and/or the first motor gear axis A_{MSG1}.

The flexion gear adaptor 432.2.10 is designed to coupled the flexion gear 432.2.4 to the drive shaft or flexion shaft 432.2.14. To accomplish this, the flexion gear adaptor 432.2.10 has a cone shaped configuration, wherein an outer extent of the cone is designed to be coupled to the flexion gear 432.2.4 and an inner extent of the cone is designed to receive an extent of the drive shaft or flexion shaft 432.2.14. Once said drive shaft or flexion shaft 432.2.14 is positioned within the flexion gear adaptor 432.2.10, the flexion coupler 432.2.12 is utilized to secure said flexion gear adaptor 432.2.10 to the drive shaft or flexion shaft 432.2.14. As such, the flexion gear 432.2.4 in geared engagement with the first motor gear 416, the worm drive gear 432.2.2 in geared engagement with the worm wheel 454.4.1, and the the drive shaft 432.2.14 coupled to both the flexion gear 432.2.4 and the worm drive gear 432.2.2 via the flexion gear adaptor 432.2.10 and flexion gear coupler 432.2.12.

The above described positional relationship allows for the rotation of the first motor shaft 412.2 about a first motor shaft axis A_{MS1} causes the first motor gear 416 to rotate around the first motor gear axis A_{MSG1}, the rotation of the first motor gear 416 causes the flexion gear 432.2.4 to rotate about the flexion axis A_{F}, the rotation of the flexion gear 432.2.4 causes the flexion gear adaptor 432.2.10 to rotate, the rotation of the flexion gear adaptor 432.2.10 causes the flexion gear coupler 432.2.12 to rotate, and the rotation of the flexion gear coupler 432.2.12 causes the drive shaft or flexion shaft 432.2.14 to rotate about the drive shaft axis A_{DS}. The drive shaft axis A_{DS} is parallel, aligned, and coaxial with the flexion axis A_{F}. As such, the drive shaft axis A_{DS} does not intersect the first motor shaft axis A_{MS1} or the first motor gear axis A_{MSG1}, said drive shaft axis A_{DS} is perpendicular to both the first motor shaft axis A_{MS1} and the first motor gear axis A_{MSG1}. Based on this configuration, the drive shaft axis A_{DS} is also perpendicular to each of the following: (i) the flexion axis A_{F}, (ii) the first motor shaft axis A_{MS1} (iii) the first motor gear axis A_{MSG1}, and (iv) first motor gear plane P_{G1}.

To allow the drive shaft or flexion shaft 432.2.14 to rotate within thumb frame 432.1, the thumb drive assembly 432.2 utilizes a first portion of the flexion bearing assembly 432.2.16. In particular, internal bearings 432.2.16.6, 432.2.16.8 that are positioned between the internal wall of the lower frame member 432.1.4 and the drive shaft or flexion shaft 432.2.14 permit said drive shaft or flexion shaft 432.2.14 to rotate within said thumb frame 432.1. Without this ability to rotate the drive shaft or flexion shaft 432.2.14 without rotating the thumb frame 432.1 is important because otherwise the movement of the first motor 412 would cause the digit assembly 408 to rotate towards or away from the palm. This is not desirable because it would significantly complicate the proper positioning of the thumb assembly 40 and would likely make certain positions impossible to reach or achieve. As such, this limitation would likely cause the end effector 10 to lack the human dexterity that is needed to complete fine and delicate tasks. Nevertheless, an alternative embodiment may couple the drive shaft or flexion shaft 432.2.14 to an extent of the thumb frame 432.1, and wherein said coupling may be biased in a certain position (e.g., open). In this alternative embodiment, the second motor 418 may be omitted and the first motor 412 may drive the digit assembly 408 inward until it reaches a resistance point. Once said resistance point has been reached, the motor 412 may continuing driving the drive shaft or flexion shaft 432.2.14 until the digit assembly 408 is fully curled around the object.

As described above, the rotation of the drive shaft or flexion shaft 432.2.14 to rotate about the drive shaft axis A_{DS}, causes the worm drive gear 432.2.2 to rotate about the worm drive gear axis A_{WDG}. The worm drive gear axis A_{WDG} is parallel, aligned, and coaxial with the flexion axis A_{F} and drive shaft axis A_{DS}. As such, the worm drive gear axis A_{WDG} does not intersect the first motor shaft axis A_{MS1} or the first motor gear axis A_{MSG1}, and said worm drive gear axis A_{WDG} is perpendicular to both the first motor shaft axis A_{MS1} and the first motor gear axis A_{MSG1}. Based on this configuration, the worm drive gear axis A_{WDG} is also perpendicular to the first motor gear plane P_{G1}. As will be discussed in greater detail below, the rotation of the worm drive gear 432.2.2 about the worm drive gear axis A_{WDG} causes the digit assembly to move (e.g., curl or uncurl).

Similar to how the rotation of the flexion gear 432.2.4 cause the digit assembly 408 to move (e.g., curl or uncurl), the rotation of the anterposition gear 432.2.6 cause the base joint assembly 432 to rotate the digit assembly 408 towards or away from the palm region 62. To enable this rotational movement of the digit assembly 408, the anterposition gear 432.2.6 is affixed to the lower frame member 432.1.4 of the thumb frame 432.1. Thus, the rotation of the anterposition gear 432.2.6 about the anterposition gear axis A_{A} causes the lower frame member 432.1.4 to rotate about a lower frame axis A_{LF}. The lower frame axis A_{LF} is parallel, aligned, and coaxial with the flexion axis A_{F}, drive shaft axis A_{DS}, and worm drive gear axis A_{WDG}. As such, the lower frame axis A_{LF} does not intersect the first motor shaft axis A_{MS1} or the first motor gear axis A_{MSG1}, and said lower frame axis A_{LF} is perpendicular to both the first motor shaft axis A_{MS1} and the first motor gear axis A_{MSG1}. Based on this configuration, the lower frame axis A_{LF} is also perpendicular to the first motor gear plane P_{G1}.

To further enable the smooth movement of the lower frame member 432.1.4 within the upper frame member 432.1.2, the thumb drive assembly 432.2 utilizes a second portion of the flexion bearing assembly 432.2.16. In particular, external bearings 432.2.16.2, 432.2.16.4 are positioned between the internal wall of the upper frame member 432.1.2 and the internal walls of the lower frame member 432.1.4. This ability to rotate the lower frame member 432.1.4 without curling/uncurling the digit assembly 408 is important because otherwise the movement of the second motor 418 would cause the digit assembly 408 to move/curl towards or away from the palm. This is not desirable because it would significantly complicate the proper positioning of the thumb assembly 40 and would likely make certain positions impossible to reach or achieve. As such, this limitation would likely cause the end effector 10 to lack the human dexterity that is needed to compete fine and delicate tasks.

In summary, the motor 412 causes: (i) first motor shaft 412.2 to rotate about a first motor shaft axis A_{MS1}, (ii) the rotation of the first motor shaft 412.2 causes the first motor gear 416 to rotate around the first motor gear axis A_{MSG1}, (iii) the rotation of the first motor gear 416 cause the flexion gear 432.2.4 to rotate about the flexion axis A_{F}, (iv) the rotation of the flexion gear 432.2.4 causes the flexion gear adaptor 432.2.10 to rotate, (v) the rotation of the flexion gear adaptor 432.2.10 causes the flexion gear coupler 432.2.12 to rotate, (vi) the rotation of the flexion gear coupler 432.2.12 causes the drive shaft or flexion shaft 432.2.14 to rotate about the drive shaft axis A_{DS}, (vii) the rotation of the drive shaft or flexion shaft 432.2.14 cause the worm drive gear 432.2.2 to rotate, (viii) the rotation of the worm drive gear 432.2.2 causes the worm wheel 454.4.1 336 to rotate, and (ix) the rotation of the worm wheel 454.4.1 336 causes the digit assembly 408 to curl/uncurl towards or away from the palm 62.

Likewise, the motor 418 causes: (i) second motor shaft 418.2 to rotate about a second motor shaft axis A_{MS2}, (ii) the rotation of the second motor shaft 418.2 causes the second motor gear 422 to rotate around the second motor gear axis A_{MSG2}, (iii) the rotation of the second motor gear 422 cause the anterposition gear 432.2.6 to rotate about the anterposition gear axis A_{A}, (iv) the rotation of the anterposition gear 432.2.6 causes the lower frame member 432.1.4 to rotate, (v) the rotation of the lower frame member 432.1.4 causes the digit assembly 408 to rotate towards or away from the palm region 62. It should be understood that alternative embodiments are contemplated herein, wherein said alternatives include changing the position of the motors 412, 418 (switching them, rotating them to be parallel or substantially parallel with the finger motors, placing them on the same side of the frame 61.2 as the finger motors, etc.).

ii. Carpometacarpal Electronics and Housing

The carpometacarpal electronics 434 may comprise a carpometacarpal encoder employing various sensing technologies, such as magnetic, optical, capacitive, or resistive systems, strategically positioned near the first carpometacarpal joint CMC₁. This encoder is configured to capture data related to the rotational movement of the joint. Such data may be utilized by the robot system to generate a vector representation, such as a spatial embedding, that reflects the current state of the digit assembly 408 or the surrounding environment. In certain embodiments, the carpometacarpal electronics 434 may acquire data either upon receiving a specific command from the robot system or at regular intervals, ranging from high-frequency sampling (e.g., 500 times per second) to periodic updates (e.g., once per minute). The data provided by the carpometacarpal encoder may include precise information about the position and movement of the first carpometacarpal joint CMC₁, enabling fine-tuned control of the thumb assembly 408.

In some implementations, the carpometacarpal encoder may integrate multiple sensing modalities, such as a combination of magnetic and optical sensing, to enhance redundancy and accuracy in detecting joint position. This multi-modal approach may enable reliable operation under diverse environmental conditions, such as variations in lighting, temperature, or magnetic interference. Furthermore, the carpometacarpal encoder may incorporate machine learning algorithms to facilitate adaptive calibration, improving accuracy over time by analyzing usage patterns. This adaptive capability may also allow the system to compensate for wear or minor misalignments that develop during prolonged operation. In addition to rotational data, the encoder may detect small translational movements or vibrations of the joint. These additional data points could be used to identify early signs of mechanical wear or looseness in the joint assembly, enabling predictive maintenance and extended system longevity. For enhanced precision, the encoder may employ a high-resolution absolute encoding scheme, which provides accurate positional data immediately after power-up without necessitating a homing sequence. This feature could significantly reduce initialization time for the thumb assembly.

To optimize data handling, the carpometacarpal electronics 434 may incorporate local data buffering and preprocessing functionalities. This design may allow high-frequency sampling and real-time filtering of joint position data, transmitting only significant state changes to the primary robot control system. Such an approach could reduce communication bandwidth requirements while maintaining system responsiveness. Additionally, the encoder system may be engineered for ultra-low power consumption, with the potential to harvest energy from the mechanical movements of the joint itself. This energy-efficient design could extend operational duration and decrease dependence on external power sources, enhancing the overall autonomy of the sensing system.

The base joint or carpometacarpal joint housing assembly 436 is designed to protect a lower extent of the thumb assembly 40 and enable a substantially smooth transition from the interior bottom housing 61.10 of the palm housing 60.1. Thus, a base gap G₁ that is formed between a bottom edge 60.1.1 of the palm housing 60.1 and an upper edge 436.10 of the base joint or carpometacarpal joint housing assembly 436. Said design of the palm housing 60.1 and the base joint or carpometacarpal joint housing assembly 436 minimizes the base gap G₁ that is formed between these two structures 60.1, 436.10. Said minimization of the base gap G₁ provides a substantial benefit over conventional end effectors 10 that include a large gap between the palm and the thumb because it: (i) minimizes the chance or probability that a glove or external covering can be caught or pinched between these housings/assemblies, (ii) provides better protection of the internal components of the thumb assembly 40, and (iii) helps seal the interworking of the thumb assembly 40 from the environment.

Additionally, the configuration of the base joint or carpometacarpal joint housing assembly 436 is significantly different from a conventional boot or flexible member, which are typically stretched between the thumb assembly 40 and the inner palm surface S_{P} of the palm housing 60.1. The differences include the following key factors: (i) the housing assembly 436 is not engineered to be substantially flexible; rather, it is designed to be substantially rigid, providing enhanced stability and durability, (ii) the entire housing 436 is intended to rotate in coordination with the thumb assembly 40, (iii) a portion of the housing 436 is not directly coupled to the palm housing 60.1, allowing for improved articulation and independent movement of the housing assembly 436, and (iv) while the base gap G₁ is minimized, said base gap G₁ remains between the palm housing 60.1 and the housing 436, which accommodates the necessary movement without causing friction or restricting motion. These distinctive features afford the housing 436 substantial advantages over a conventional boot design. Specifically, the disclosed housing 436 design: (i) does not obstruct or interfere with the contact between the end effector 10 and the object with which the end effector 10 is interacting, ensuring optimal performance and precision, (ii) is resistant to tearing or rapid degradation, even when the end effector 10 encounters sharp objects such as sheet metal, and (iii) additional benefits, which will be apparent to those skilled in the art, can be derived from these design elements as disclosed herein.

The base joint or carpometacarpal joint housing assembly 436 has an overall shape that is similar to a checkmark or tick and includes: (i) an interior, upper member 436.1, (ii) an exterior, upper member 436.2, and (iii) a lower member 436.3. Each of the members 436.1, 436.2, 436.3 include interior mounting projections 436.10 that extend inward and are designed to be coupled to the thumb frame 432.1 (and specifically, the carpometacarpal or base joint housing coupling points 432.1.4.1) using elongated mechanical fasteners. It should be understood that alternative coupling means are contemplated by this disclosure, including snaps, press-fit, other mechanical interacting structures, and/or any other known method of mechanical coupling. Further, it should be understood that the number of members contained within the housing assembly 436 may increase or decrease depending on the needs and configuration of said thumb drive assembly 432.2.

As shown in FIGS. 20-24, the base joint or carpometacarpal joint housing assembly 436 is configured to surround or at least substantially surround a portion of: (i) lower frame member 432.1.4, (ii) worm drive gear 432.2.2, and (iii) proximal link assembly 454. To surround or at least substantially surround the above components, the base joint or carpometacarpal joint housing assembly 436 forms a base joint receiver 436.20. The base joint receiver 436.20 is designed to receive: (i) an extent of the proximal assembly 450 (namely, a rear extent of the proximal housing assembly 452), when the thumb assembly 40 is in the open, uncurled, or neutral position, and (ii) a lesser extent of, or none of, the proximal assembly 450 (namely, the rear extent of the proximal housing assembly 452), when the thumb assembly 40 is in the closed, curled, or inwardly rotated position. In other words, the base joint housing assembly 436 overlies: (i) an extent of the proximal housing assembly 452 when the thumb assembly 40 is in the open, uncurled, or neutral position, and (ii) none of the proximal housing assembly 452 when the thumb assembly 40 is in the closed, curled, or inwardly rotated position. Stated another way, the percentage of the proximal housing assembly 452 (namely, the rear extent of the proximal housing assembly 452) that is positioned within the base joint housing assembly 436 is reduced when the thumb assembly 40 moves from the open, uncurled, or neutral position to the closed, curled, or inwardly rotated position. By enabling at least a minimal extent of the proximal housing assembly 452 to be positioned within or adjacent to the base joint housing assembly 436, the gap G₂ formed between the assemblies 432 and 450 is minimized, and wherein said minimization of said gap G₂ is beneficial because it minimizes the chance or probability that a glove or external covering can be caught or pinched between these assemblies.

a. Proximal Assembly

The proximal assembly 450 is positioned between the base joint assembly 430 and the medial assembly 470 and is the first portion of the thumb assembly 40 that is configured to move relative to the housing frame 61.2 and the palm 62 in response to actuation of the first motor 412 and worm drive gear 432.2.2. The proximal assembly 450 includes: (i) a proximal housing assembly 452, (ii) a proximal link assembly 454, and (iii) the worm wheel interface 456.

i. Proximal Housing Assembly

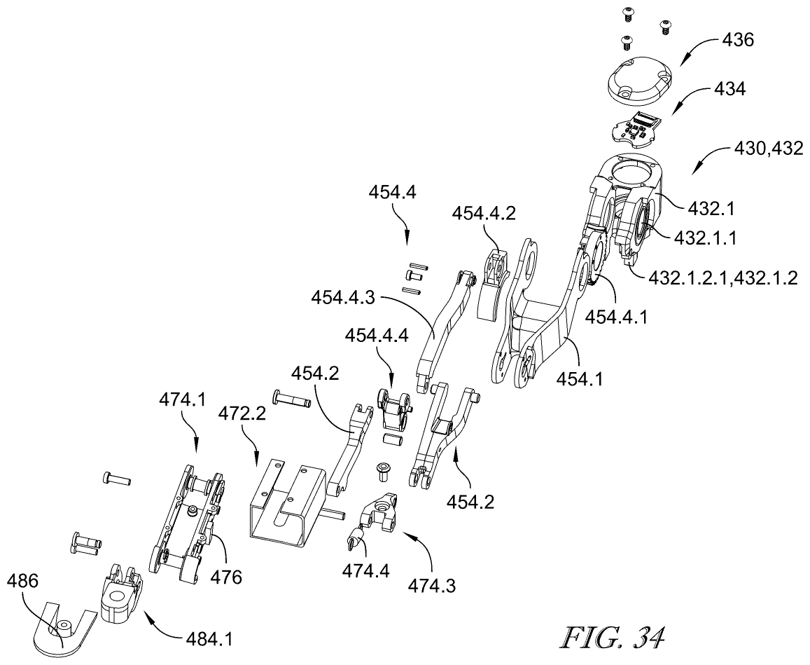

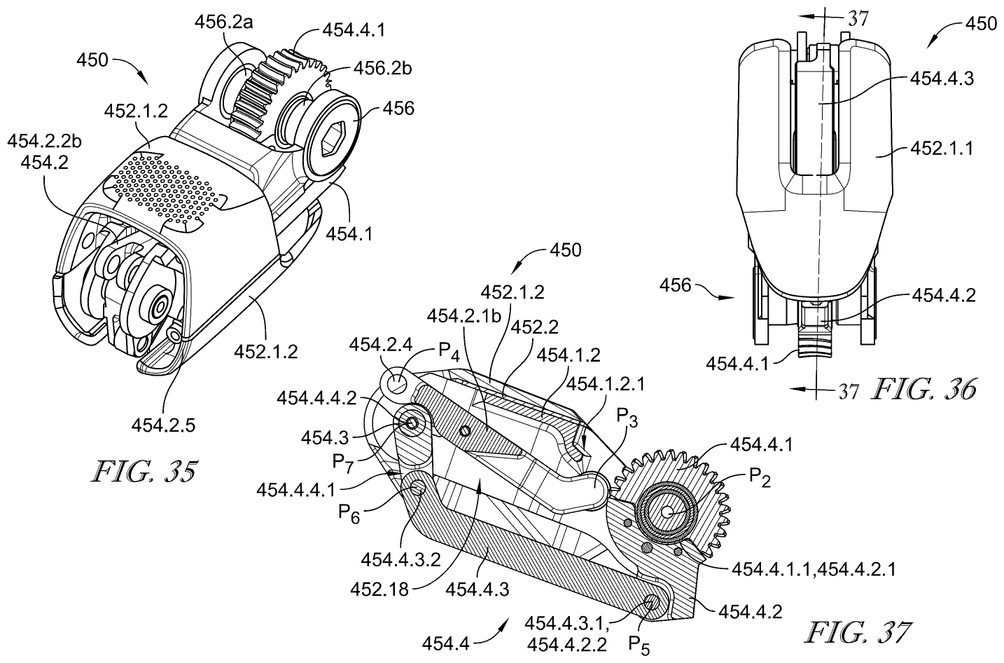

As shown in FIGS. 20-24 and 35-37, the proximal housing assembly 452 is designed to substantially surround a majority of the other components of the proximal assembly 450. To achieve this, the proximal housing assembly 452 forms an internal proximal recess 452.18. Unlike the finger assemblies 22a-22d, the internal proximal recess 452.18 is not designed to receive an extent of the medial assembly 470 (namely, the medial tongue) when the thumb assembly 40 is in the open, uncurled, or neutral position. Instead, an extent of said proximal housing assembly 452 is designed to be positioned near or adjacent to the medial housing 472. This configuration helps ensure that the gap G₃ formed between the assemblies 450 and 470 is minimized, and wherein said minimization of said gap G₃ is beneficial because it minimizes the chance or probability that a glove or external covering can be caught or pinched between these assemblies 450, 470.

In an alternative embodiment, the proximal housing assembly 452 may be configured to overlie: (i) a substantial extent of a medial tongue when the thumb assembly 40 is in the open, uncurled, or neutral position, and (ii) a minor extent of, or none of, the medial tongue when the thumb assembly 40 is in the closed, curled, or inwardly rotated position. Stated another way, the percentage of the medial assembly 470 (namely, the medial tongue) that is positioned within the proximal housing assembly 452 is reduced when the thumb assembly 40 moves from the open, uncurled, or neutral position to the closed, curled, or inwardly rotated position. This configuration may further minimize the size of gap G₂, which may further minimizes the chance or probability that a glove or external covering can be caught or pinched between these assemblies 450, 470.

As shown in FIGS. 20-24 and 35-37, the proximal housing assembly 452 specifically includes: (i) a proximal jacket assembly 452.1 with a top member 452.1.1 and a bottom member 452.1.2, and (ii) a proximal bottom casing assembly 452.2. While the bottom member 452.1.2 is in direct contact with and underlies the proximal bottom casing assembly 452.2, the thumb assembly 40 lacks a proximal top casing assembly that is in direct contact with the top member 452.1.1. This design is advantageous because the proximal bottom casing assembly 452.2 provides the bottom member 452.1.2 with additional rigidity, which enables said bottom member 452.1.2 to be made from a softer, easier-to-form, and potentially less durable material, thereby increasing the gripping capability of the end effector 10. In contrast, the top member 452.1.1 does not need to include a softer, easier-to-form, and potentially less durable material because said top member 452.1.1 is not designed to come into regular contact with objects. Additionally, even if the materials of the proximal bottom casing assembly 452.2 and the bottom member 452.1.2 are the same, it may be desirable to form these components as two separate components to facilitate replaceability without exposing an inner extent of the thumb assembly 40. Another way of describing this beneficial configuration includes the fact that the proximal jacket assembly 452.1 is configured to provide the primary external shape of the thumb assembly 40, while the proximal casing assembly 452.2 is configured to protect the internal workings of said thumb assembly 40. Nevertheless, it should be understood that in an alternative embodiment, the bottom member 452.1.2 and the proximal bottom casing assembly 452.2 may be integrally formed as a single structure.

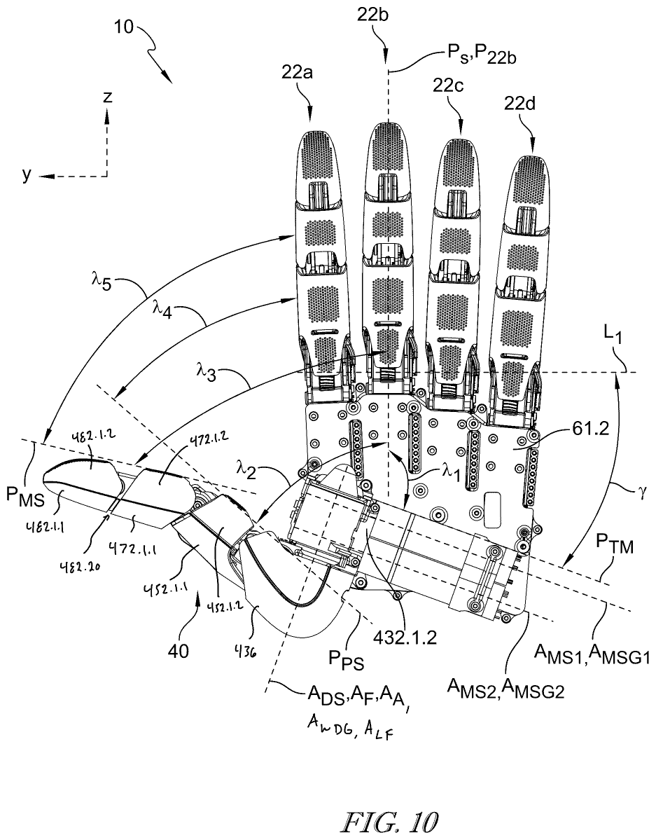

As best shown in FIGS. 11-12, 20-24, and 35-37, the top member 452.1.1 of the proximal jacket assembly 452.1 includes an exterior surface back with a curvilinear extent in a first direction (namely, across the width of the thumb assembly 40), and the bottom member 452.1.2 of the proximal jacket assembly 452.1 includes an exterior palm surface 61.2.2 with a curvilinear extent in the first direction (namely, across the width of the thumb assembly 40) and a second direction (namely, across the length of the thumb assembly 40). The curvilinear extent in the first direction helps ensure that the thumb assembly 40 has rounded edges to help with grasping objects, while the curvilinear extent in the second direction helps ensure that the thumb assembly 40 can curl inward. As discussed above, the proximal housing assembly 452 may be: (i) made from the same materials as the housing assembly 60, (ii) made from material that differs from the materials used in the housing assembly 60, and/or (iii) may include silicon, plastic (e.g., may include a polymer composition), carbon composite, or metal, a combination of these materials, any other material disclosed herein, and/or any other suitable material. Alternatively, the proximal housing assembly 452 may include additional components or layers (e.g., between three and an nth).

iii. Proximal Link Assembly

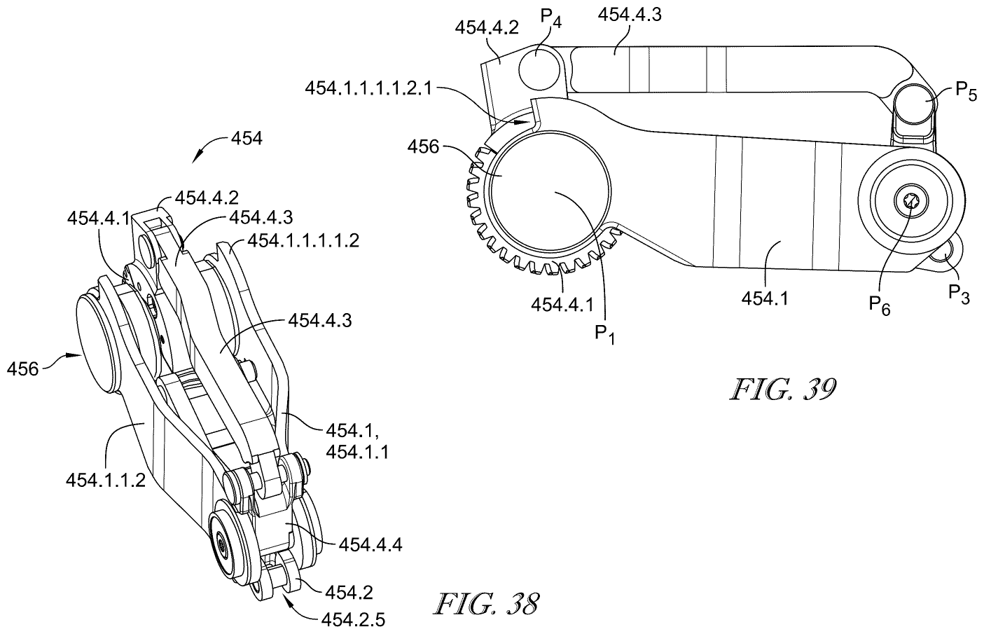

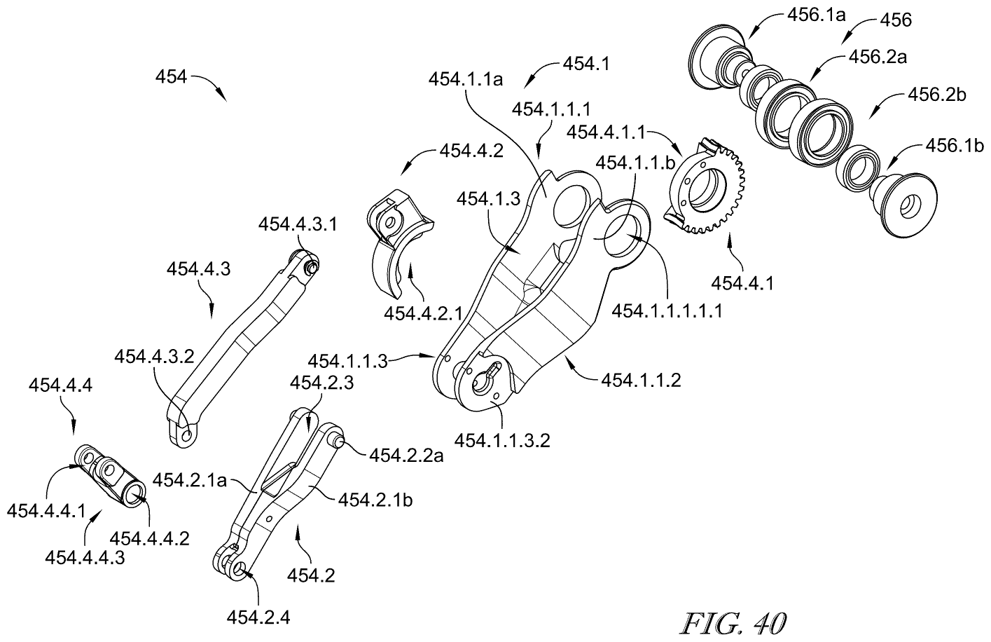

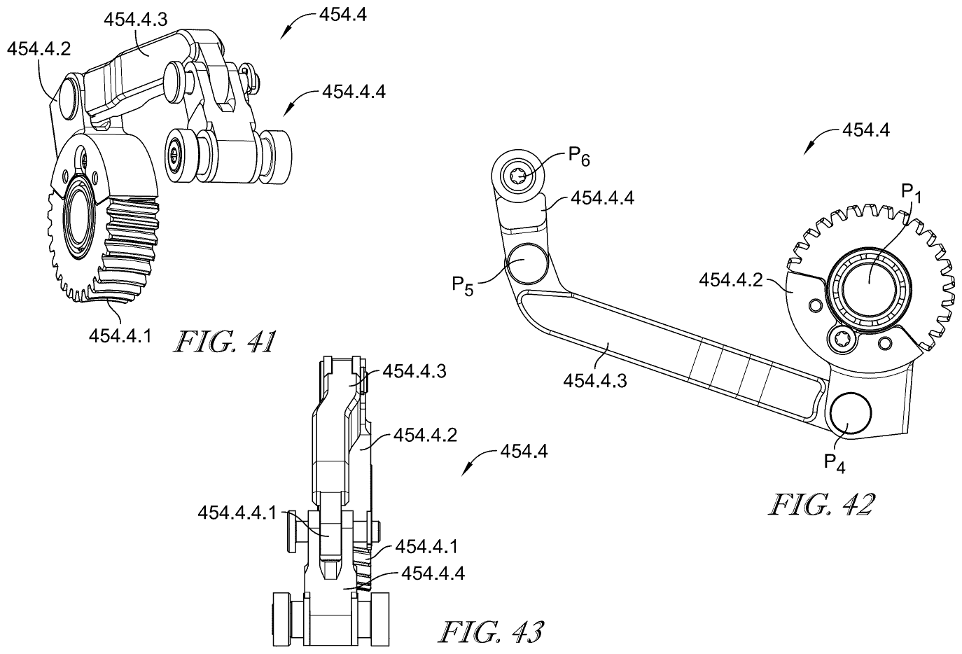

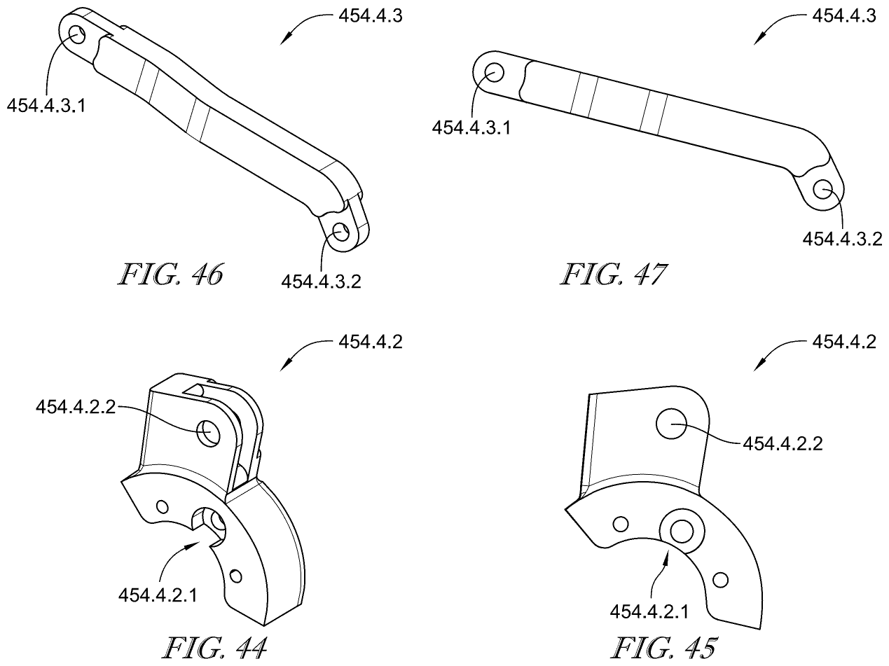

As shown in FIGS. 20-24 and 35-54, the proximal link assembly 454 includes: (i) a primary or main proximal link or first bar 454.1, (ii) coupling link 454.2, (iii) a medial assembly coupler 454.3, and (iv) a proximal drive link assembly 454.4. The proximal link assembly 454 is involved with all movements of the thumb assembly 40, wherein its angular position can be altered based on the curling of an extent of the assembly 40 and its rotational position can be altered based on rotating the assembly 40. In other words, at least one aspect of the proximal link assembly 454 must move in some aspect in order to cause any portion of the thumb assembly 40 to move. As discussed above, this disclosure is in contrast to conventional end effectors and/or conventional fingers. This configuration is beneficial because it reduces complexities, components, cost, and weight, while increasing reliability.

### 1. Main Proximal Link

The primary or main proximal link or first bar 454.1 is best shown in FIGS. 20-24, 34-40, and 48-50. The main proximal link 454.1 includes: (i) first and second frame members 454.1.1a, 454.1.1b, (ii) proximal link bridge 454.1.2, and (iii) a proximal link recess 454.1.3. The first and second frame members 454.1.1a, 454.1.1b are comprised of: (i) a first proximal link segment 454.1.1.1a, 454.1.1.1b that extends from a rearmost extent of the main proximal link 454.1 to a first proximal link plane P_{L1}, (ii) a second proximal link segment 454.1.1.2a, 454.1.1.2b that extends from the first proximal link plane P_{L1} to the second proximal link plane P_{L2}, and (iii) a third proximal link segment 454.1.1.3a, 454.1.1.3b that extends forward from the second proximal link plane P_{L2} to the forward most extent of the main proximal link 454.1.

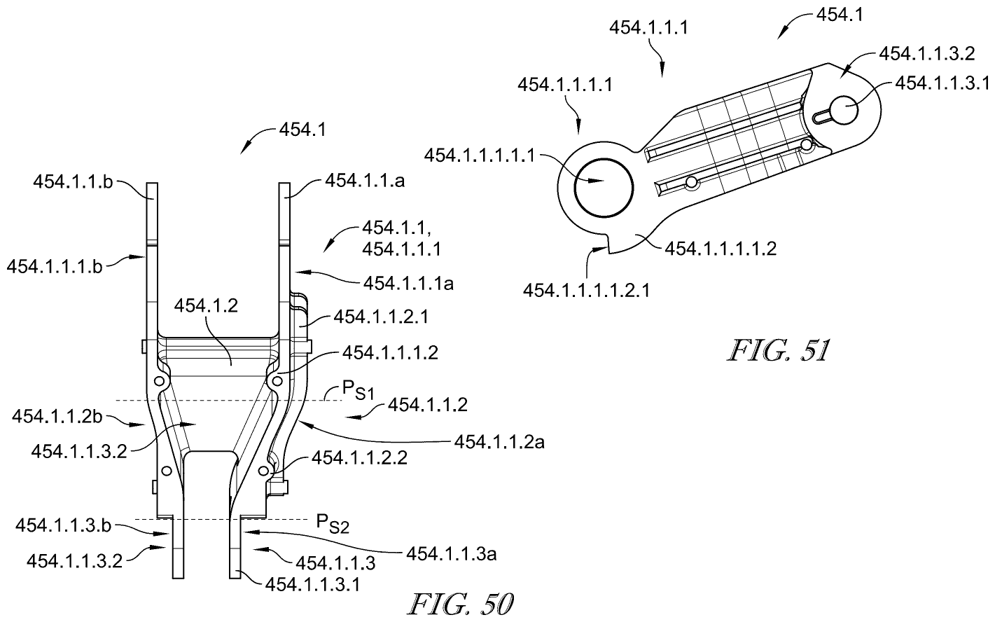

As shown in FIG. 50, the second left and right segments 454.1.1.2a, 454.1.1.2b taper inward as they extend from line P_{L1} to line P_{L2}, which reduces the overall width of the link 454.1. The reduction in width is beneficial because it allows for a reduction in the width of the thumb assembly 40 to aid in gripping objects. It should be understood that in other embodiments, the taper may be more significant or may be eliminated. Also, as shown in FIG. 54, first right and left segments 454.1.1.1a, 454.1.1.1b are substantially parallel with one another, but are not aligned with the third right and left segments 454.1.1.3a, 454.1.1.3b. In other embodiments, said first and third left and right segments 454.1.1.1a, 454.1.1.1b, 454.1.1.3a, 454.1.1.3b may not be substantially parallel with one another and/or may be substantially aligned with other components of the main proximal link 454.1.

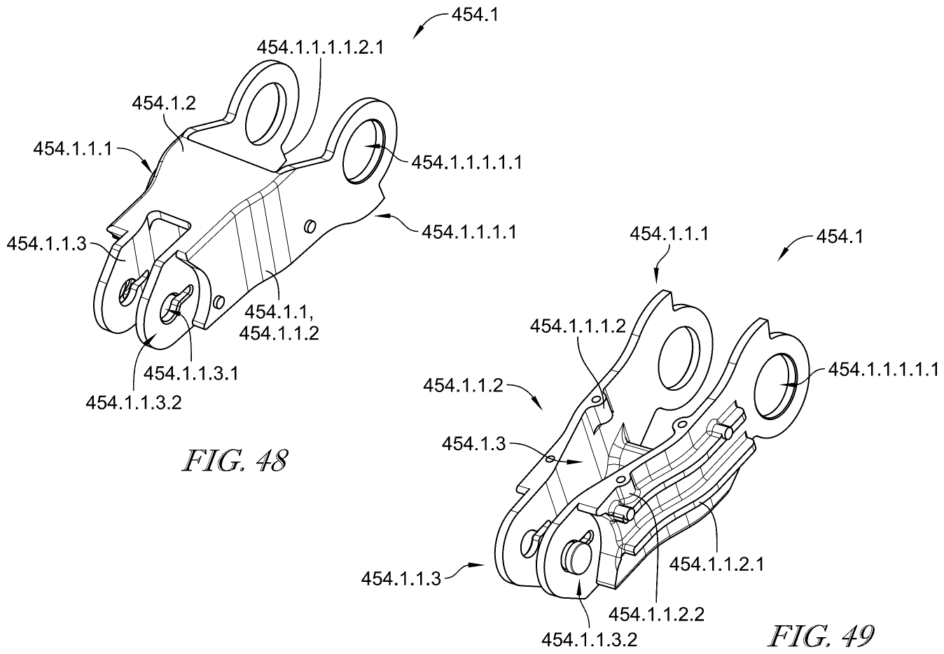

As shown in FIGS. 48-51, the first proximal link segment 454.1.1.1 includes a second joint or carpometacarpal joint CMC₂ with a carpometacarpal joint coupler 454.1.1.1.1 having an axel aperture 454.1.1.1.1.1 and stopping projection 454.1.1.1.1.2. The axel aperture 454.1.1.1.1.1 of the carpometacarpal joint coupler 454.1.1.1.1 is circular and is designed to receive an extent of the worm wheel assembly 456 (which will be discussed later). It should be understood that non-circular configurations of the axel aperture 454.1.1.1.1 are contemplated by this disclosure (e.g., tear-drop). Referring to FIG. 51, the stopping projection 454.1.1.1.1.2 is positioned in a lower extent of the first proximal link segment 454.1.1.1. When the proximal assembly 450 is in the curled position, a second limiting interface region 454.1.1.1.1.2.1 of the stopping projection 454.1.1.1.1.2 is designed to interact with an extent of the joint frame member 232.1. It should be understood that the above described interface region 454.1.1.1.1.2.1 may not make contact with the described adjacent structures. Instead, a gap may be present between these structures regardless of the state of the thumb assembly 40.

As shown in FIGS. 48-51, the second proximal link segment 454.1.1.2 is not aligned with either the first or third segments 454.1.1.1, 454.1.1.3 and includes: (i) elongated ribs 454.1.1.2.1 that extend from a side of the proximal frame member 454.1.1a, (ii) second set of housing mounting projections 454.1.1.2.2, wherein the first set of housing mounting projections 454.1.1.1.2 were a component of the first proximal link segment 454.1.1.1. The housing mounting projections 454.1.1.1.2, 454.1.1.2.2 are configured to couple the proximal jacket assembly 452.1 to the proximal link assembly 454. Other methods of coupling said assemblies 452.1, 454 to one another are contemplated by this disclosure, including clips, press-fits, or other mechanical coupling means.

Like the frame members 454.1.1a, 454.1.1b of the first segment 454.1.1.1, the frame members 454.1.1a, 454.1.1b of the third segment 454.1.1.3 are substantially parallel to one another. Additionally, the third proximal link segment 454.1.1.3 also includes: (i) a medial assembly opening 454.1.1.3.1 configured to receive a securement means 454.3 that couples the main proximal link 454.1 to the jumper 454.4.4 of the proximal drive link assembly 454.4 to form the fifth pivot point P₅, and (ii) a medial assembly recess 454.1.1.3.2 to ensure that said securement means 454.3 does not interfere with the movement of any of the links contained within the thumb assembly 40. It should be understood that the securement means is contemplated by this disclosure, including any mechanical coupler (e.g., pin and clip). Also, the medial assembly recess 454.1.1.3.2 may be omitted or the nesting of components may be altered in other embodiments.

As shown in FIGS. 37, 38, 40, 49, and 50, the proximal bridge 454.1.4 extends between an extent of the first and second proximal frame members 454.1.1a, b. Thus, a U-shaped member with a proximal link recess 454.1.3 is formed from the combination of the proximal bridge 454.1.4 and the proximal frame members 454.1.1a,b. Said proximal link recess 454.1.3 is designed to receive different extents of the coupling link 454.2 and proximal drive link assembly 454.4 depending on the position of the thumb assembly 40. The proximal bridge 454.1.4 also includes a third limiting interface region 454.1.2.1 designed to interact with the first limiting interface region 432.1.2.1 when the thumb assembly 40 is fully curled. Modifications to the location and configuration of the interface regions 432.1.2.1, 454.1.2.1 is contemplated by this disclosure.

### 2. Coupling Link

As shown in FIGS. 37, 38, and 52-54, the coupling link or fourth bar 454.2 secures the frame 432.1 of the base joint assembly 430 to the biasing assembly 474.4 of the medial link assembly 474. As such, the coupling link or fourth bar 454.2 includes a first end that is pivotally coupled at a third pivot point P₃ to said thumb frame 432.1 and a second end that is pivotally coupled at a fourth pivot point P₄ to said Y-link 474.3. Thus, the third and fourth pivot points P₃, P₄. The coupling link 454.2 is comprised of left and right portions 454.2.1a, 454.2.1b, which when assembled allow the coupling link 454.2 to include: (i) frame projections 454.2.2a, 454.2.2b that are configured to be received by an extent of the frame 432.1, (ii) link assembly recess 454.2.3, which is configured to receive an extent of the proximal drive link assembly 454.4 when said thumb assembly 40 is in the curled position, (iii) a Y-link opening 454.2.4 and a Y-link recess 454.2.5, both of which are configured to allow said coupling link 454.2 to interact with the Y-link 474.3 of the medial link assembly 474. This configuration also ensures that the coupling link or fourth bar 454.2 is supported on two sides of a plane that bisects the length of the thumb assembly 40. It should be understood that in other embodiments, the coupling link 454.2 may be combined with other links or may be omitted.

### 3. Proximal Drive Link Assembly

As shown in in FIGS. 34-47, the proximal drive link assembly 454.4 includes: (i) worm wheel 454.4.1, (ii) a worm wheel coupler 454.4.2, (iii) worm drive link or second bar 454.4.3, (iv) jumper or third bar 454.4.4. The worm wheel 454.4.1 is a semi-circular toothed gear that is designed to be in geared engagement with the worm drive gear 432.2.2 and is configured to facilitate the movement of the thumb assembly from a uncurled position to a curled position. In particular, the worm wheel 454.4.1 includes: (i) a toothed section that includes 18 teeth that encircle 220 degrees of the worm wheel 454.4.1, (ii) a recessed portion 454.4.2.1 that is designed to receive an extent of the worm wheel coupler 454.4.2, and (iii) a central bearing opening 454.4.1.2 that are designed to receive a first and second worm bearings 456.2a, 456.2b (as discussed below). Said worm wheel 454.4.1 is designed to rotate about a worm wheel axis Aww, wherein said worm wheel axis Aww is located at the center of the central bearing opening 454.4.1.2 and the second pivot point P₂. It should be understood that in other embodiments, the worm wheel 236 may include additional teeth (e.g., between 19 and 50) or fewer teeth (e.g., between 5 and 17). Additionally, the toothed section 236.2 may span more than 220 degrees (e.g., between 221 and 300 degrees) or span less than 220 degrees (e.g., between 100 and 119 degrees).

The worm wheel coupler 454.4.2 includes a worm drive link opening 454.4.2.2 that is designed to couple said worm wheel 454.4.1, via the worm wheel coupler 454.4.2, to the worm drive link or second bar 454.4.3. Further, the worm wheel coupler 454.4.2 includes other features that permit the transfer of energy from the worm wheel 454.4.1 to the assemblies 480, 470 of the thumb assembly 40. For example, said worm wheel 454.4.1 includes a recess that is positioned adjacent to the worm wheel interface region 454.4.1.3 and is configured to ensure that a coupler does not interfere with the movement of the worm wheel assembly 456. However, it should be understood that the recess may be omitted in other embodiments and or said worm wheel 454.4.1 may be sealed within the motor assembly 410.

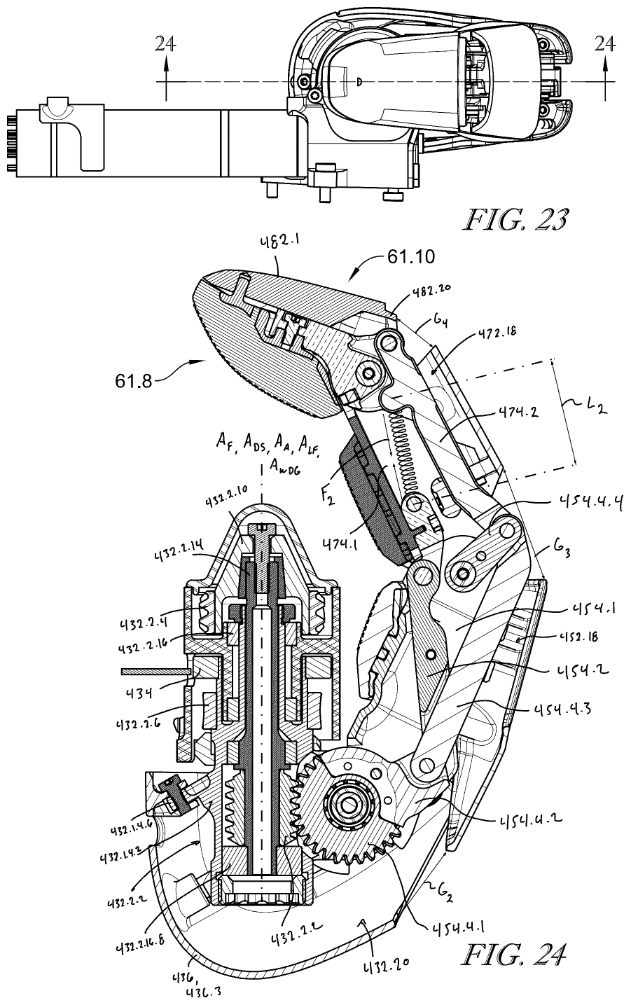

The worm drive link 454.4.3 includes: (i) a wheel coupler opening 454.4.3.1 that is configured to receive a coupler designed to pivotally secure said worm drive link 454.4.3 to the worm wheel coupler 454.4.2 at the fifth pivot point P₅, and (ii) a proximal drive link opening 454.4.3.2 that is configured to receive a coupler designed to pivotally secure said worm drive link 454.4.1 to the jumper 454.4.4 and the medial drive link 474.2 at the sixth pivot point P₆. Due to the worm drive link's 454.4.3 design and as shown in FIGS. 21 and 24, an extent of the link is designed to move from outside of the primary or main proximal link or first bar 454.1 to within said primary or main proximal link or first bar 454.1. As such, the fifth and sixth pivot points are not fixed and thus are configured to move in response to the movement of the digit assembly 408.

Said jumper 454.4.4 includes: (i) proximal drive link opening 454.4.4.1 that is configured to receive a coupler designed to secure said jumper 454.4.4 to the worm drive link 454.4.3 and the medial drive link 474.2, (ii) a main link opening 454.4.4.2 that is configured to receive a coupler designed to secure said jumper 454.4.4 to the main proximal link 454.1. The combination of these links 454.4.2, 454.4.3, 454.4.4 enables the transfer of the movement from the worm wheel 454.4.1 to the medial assembly 470. Due to this transfer of movement, the angles formed between the following links change depending on the position of the digit assembly 408: (i) the worm wheel coupler 454.4.2 and the worm drive link 454.4.3, (ii) the worm drive link 454.4.3 and jumper 454.4.4, (iii) jumper 454.4.4 and the medial drive link 474.2, and (iv) the worm drive link 454.4.3 and the medial drive link 474.2.

iv. Worm Wheel Assembly

The worm wheel assembly 456 includes first and second worm locking members 456.1a, 456.1b, along with first and second worm bearings 456.2a, 456.2b. The worm wheel assembly 456 utilizes the configuration of the locking members and bearings 456.1a, 456.1b, 456.2a, 456.2b to allow the main proximal link 454.1 to remain in a fixed position once it has come into contact with a resistance point/surface, while the motor assembly 410 continues to drive the proximal drive link assembly 454.4 (causing movement of the medial and distal assemblies 470, 480). In other words, the bearings 456.1a, 456.1b allow the main proximal link 454.1 to stop rotating even when the worm wheel 454.4.1 continues to rotate. Said continued rotation of the worm wheel 454.4.1 enables the thumb assembly 40 to move the biasing member 474.4.1 from the first or collapsed position to a second or extended position, which enables the medial and distal assemblies 470, 480 to continue curling about said object. It should be understood that without this slippage between the main proximal link 454.1 and the worm wheel 454.4.1 436, the thumb assembly 40 could not rotate the medial and distal assemblies 470, 480 once the proximal assembly 450 came into contact with a resistance point/surface.

b. Medial Assembly

The medial assembly 470 is positioned between the proximal assembly 450 and the distal assembly 480 and is the second portion of the thumb assembly 40 configured to move relative to the palm 62. The medial assembly 470 includes: (i) a medial housing assembly 472, and (ii) a medial link assembly 474.

i. Medial Housing Assembly

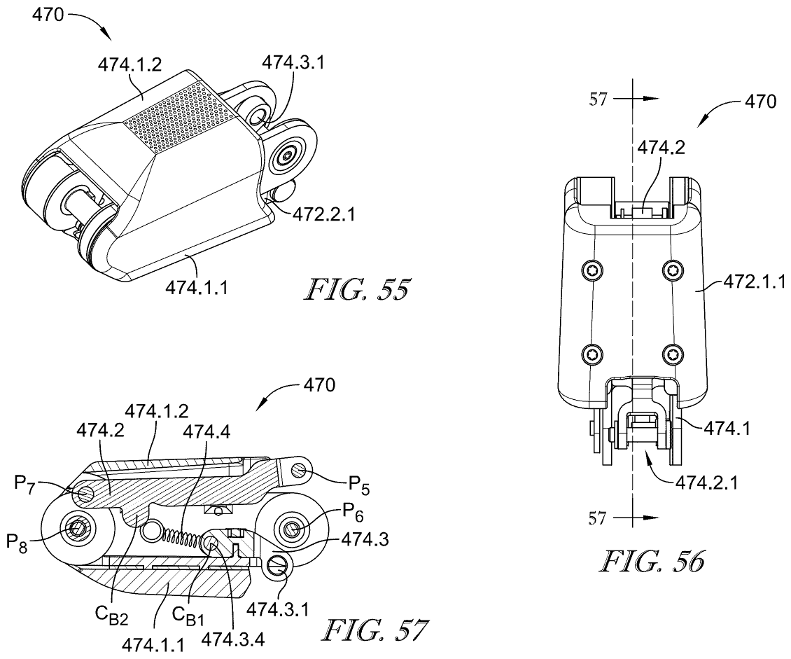

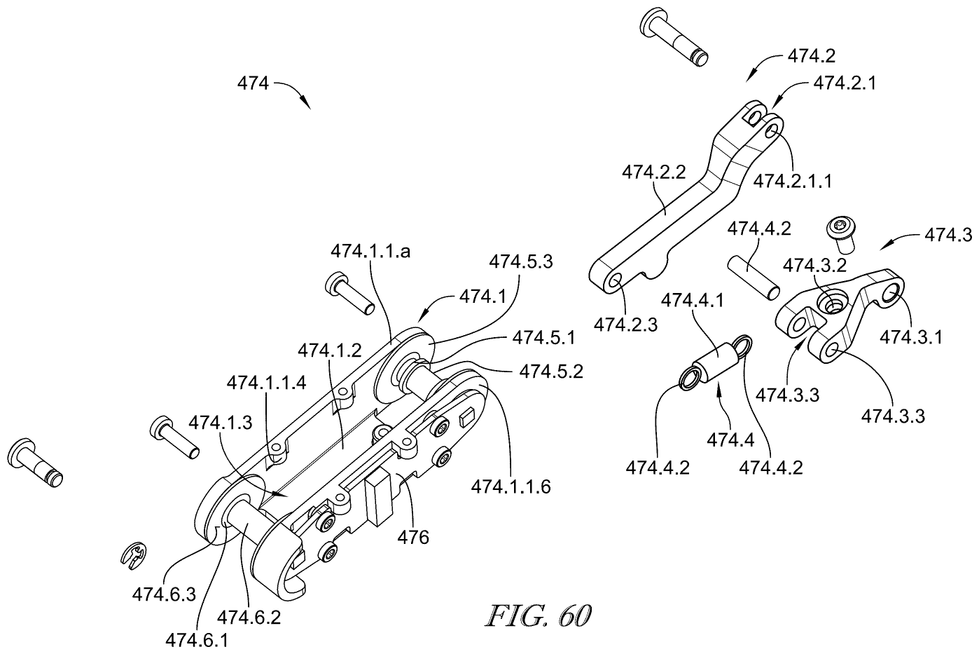

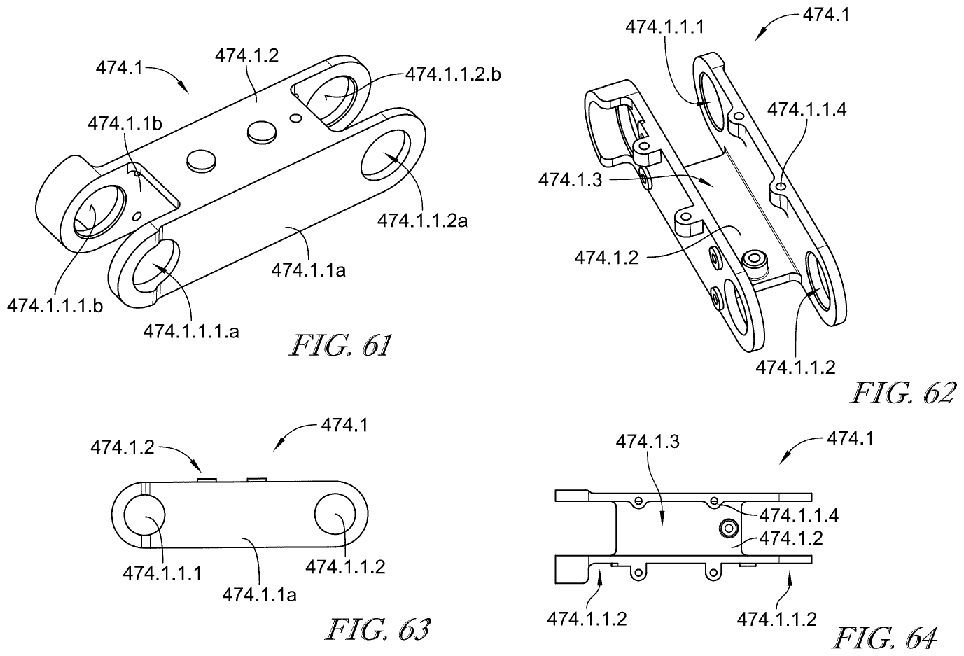

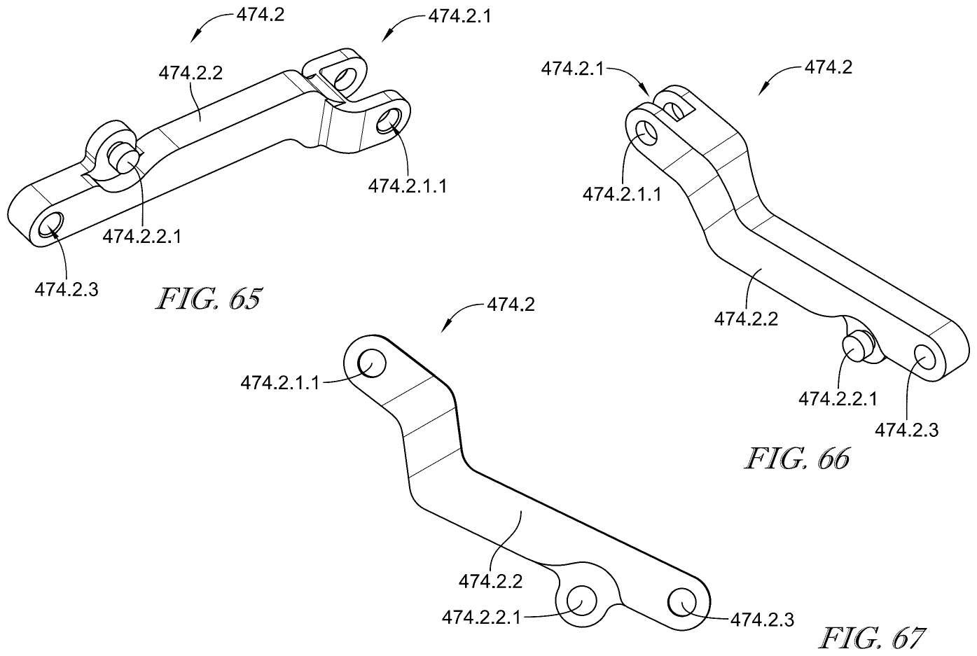

As shown in FIGS. 20-24 and 55-67, the medial housing assembly 472 is designed to substantially surround a majority of the other components of the medial assembly 470. To achieve this, the medial housing assembly 472 forms an internal medial recess 472.18. The internal medial recess 472.18 is designed to not only surround components of the medial assembly 470, but is also designed to receive: (i) an extent of the distal assembly 480 (namely, the distal tongue 482.20), when the thumb assembly 40 is in the open, uncurled, or neutral position, and (ii) a lesser extent of, or none of, the distal assembly 480 (namely, the distal tongue 482.20), when the thumb assembly 40 is in the closed, curled, or inwardly rotated position. In other words, the medial housing assembly 472 overlies: (i) a substantial extent of the distal tongue 482.20 when the thumb assembly 40 is in the open, uncurled, or neutral position, and (ii) a minor extent of, or none of, the distal tongue 482.20 when the thumb assembly 40 is in the closed, curled, or inwardly rotated position. Stated another way, the percentage of the distal assembly 480 (namely, the distal tongue 482.20) that is positioned within the medial housing assembly 472 is reduced when the thumb assembly 40 moves from the open, uncurled, or neutral position to the closed, curled, or inwardly rotated position. By enabling at least a minimal extent of the distal assembly 480 (namely, the distal tongue 482.20) to be positioned within or adjacent to the medial assembly 470, the gap G₄ formed between the assemblies 470 and 480 is minimized, and wherein said minimization of said gap G₄ is beneficial because it minimizes the chance or probability that a glove or external covering can be caught or pinched between these assemblies.

As shown in FIGS. 20-24 and 55-57, the medial housing assembly 472 specifically includes: (i) a medial jacket assembly 472.1 with a top member 472.1.1 and a bottom member 472.1.2, and (ii) a medial bottom casing assembly 472.2. While the bottom member 472.1.2 is in direct contact with and underlies the medial bottom casing assembly 472.2, the thumb assembly 40 lacks a medial top casing assembly that is in direct contact with the top member 472.1.1. This design is advantageous because the medial bottom casing assembly 472.2 provides the bottom member 472.1.2 with additional rigidity, which enables said bottom member 472.1.2 to be made from a softer, easier-to-form, and potentially less durable material, thereby increasing the gripping capability of the end effector 10. In contrast, the top member 472.1.1 does not need to include a softer, easier-to-form, and potentially less durable material because said top member 472.1.1 is not designed to come into regular contact with objects. Additionally, even if the materials of the medial bottom casing assembly 472.2 and the bottom member 472.1.2 are the same, it may be desirable to form these components as two separate components to facilitate replicability without exposing an inner extent of the thumb assembly 40. Another way of describing this beneficial configuration includes the fact that the medial jacket assembly 472.1 is configured to provide the primary external shape of the thumb assembly 40, while the medial casing assembly 472.2 is configured to protect the proximal PCB 458 and provide a spacer between the medial link assembly 474 and the medial jacket assembly 472.1. Nevertheless, it should be understood that in an alternative embodiment, the bottom member 472.1.2 and the medial bottom casing assembly 472.2 may be integrally formed as a single structure.

As best shown in FIGS. 20-24, the top member 472.1.1 of the medial jacket assembly 472.1 includes an exterior surface back with a curvilinear extent in a first direction (namely, across the width of the thumb assembly 40), and the bottom member 472.1.2 of the medial jacket assembly 472.1 includes an exterior palm surface that is curvilinear extent in the first direction (namely, across the width of the thumb assembly 40) and a second direction (namely, across the length of the thumb assembly 40). The curvilinear extent in the first direction helps ensure that the thumb assembly 40 has rounded edges to help with grasping objects, while the curvilinear extent in the second direction helps ensure that the finger can curl inward.

As discussed above, the medial housing assembly 472 may be: (i) made from the same materials as the housing assembly 60, (ii) made from materials that differ from the materials used in the housing assembly 60, and/or (iii) may include silicon, plastic (e.g., may include a polymer composition), carbon composite, or metal, a combination of these materials, and/or any other know material used in robot systems. Alternatively, the medial housing assembly 472 may include additional components or layers (e.g., between three and an nth). It should be also be understood in alternative embodiments that the medial jacket assembly 472.1 and the medial casing assembly 472.2 may be combined into a single component and/or additional exterior members may be added to the end effector 10/thumb assembly 40.

ii. Medial PCB

The medial PCB 476 may include a first thumb encoder (e.g., magnetic, optical, capacitive, resistive, etc.) that is positioned adjacent to the metacarpophalangeal joint and configured to collect metacarpophalangeal joint data and a second thumb encoder (e.g., magnetic, optical, capacitive, resistive, etc.) that is positioned adjacent to the interphalangeal joint and configured to collect interphalangeal joint data. The metacarpophalangeal joint data and the interphalangeal joint data are a part of the curl data. Said curl data may use the robot system to generate a vector representation (e.g., a space embedding) indicating the state of the proximal, medial, and distal assemblies 450, 470, 480 or the environment around the said assemblies 450, 470, 480. The encoder of the medial PCB 476 may collect data upon a specific command from the robot system or periodically (e.g., between 500 times per second to every minute). It should be understood that the robot system's knowledge of the position of the proximal, medial, and distal assemblies 450, 470, 480 is highly desirable because said robot system may lack other sensors that a conventional robot system utilizes and/or relies on to grasp or manipulate objections. In particular, said end effector 10 (including the finger assemblies 22a-22d and the thumb assembly) 40 may lack pressure sensors that are heavily relied upon in conventional end effectors and instead merely rely on determining the size and position of objections and the knowledge of the position of components contained in the end effector 10.

In some implementations, the first and second thumb encoders may integrate multiple sensing modalities, such as a combination of magnetic and optical sensing, to enhance redundancy and accuracy in detecting joint position. This multi-modal approach may enable reliable operation under diverse environmental conditions, such as variations in lighting, temperature, or magnetic interference. Furthermore, the first and second thumb encoders may incorporate machine learning algorithms to facilitate adaptive calibration, improving accuracy over time by analyzing usage patterns. This adaptive capability may also allow the system to compensate for wear or minor misalignments that develop during prolonged operation. In addition to rotational data, the first and second thumb encoders may detect small translational movements or vibrations of the joint. These additional data points could be used to identify early signs of mechanical wear or looseness in the joint assembly, enabling predictive maintenance and extended system longevity. For enhanced precision, the first and second thumb encoders may employ a high-resolution absolute encoding scheme, which provides accurate positional data immediately after power-up without necessitating a homing sequence. This feature could significantly reduce initialization time for the thumb assembly.

To optimize data handling, the first and second thumb encoders may incorporate local data buffering and preprocessing functionalities. This design may allow high-frequency sampling and real-time filtering of joint position data, transmitting only significant state changes to the primary robot control system. Such an approach could reduce communication bandwidth requirements while maintaining system responsiveness. Additionally, the first and second thumb encoders may be engineered for ultra-low power consumption, with the potential to harvest energy from the mechanical movements of the joint itself. This energy-efficient design could extend operational duration and decrease dependence on external power sources, enhancing the overall autonomy of the sensing system.

iii. Medial Link Assembly

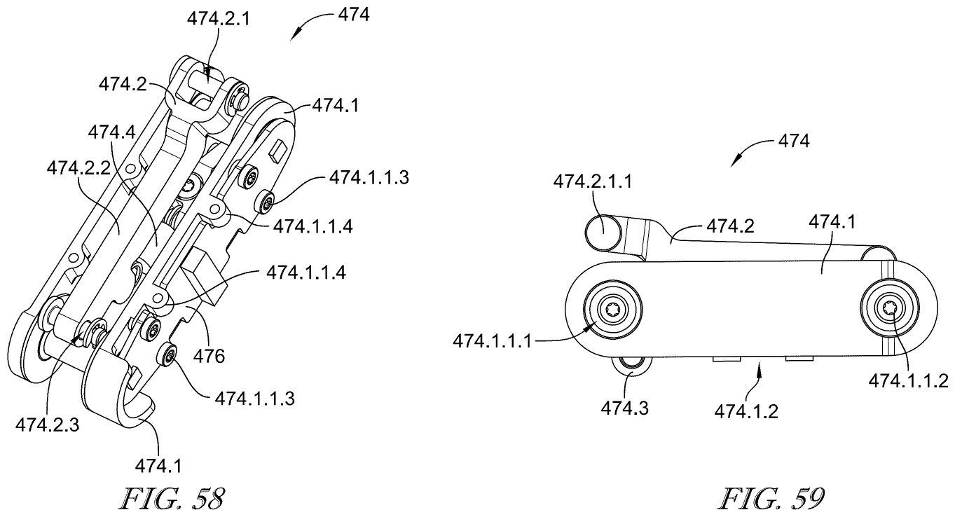

As shown in FIGS. 58-67, the medial link assembly 474 includes: (i) a primary or main medial link or fifth bar 474.1, (ii) a medial drive link or sixth bar 474.2, (iii) a Y-link or seventh bar 474.3, and (iv) a biasing assembly 474.4. The medial link assembly 474 is involved with a majority of the movements of the thumb assembly 40. While the proximal assembly 450 could move without causing a positional change between said proximal assembly 450 and the medial assembly 470, the distal assembly 480 cannot move without causing a positional change between said distal assembly 480 and the medial assembly 470. Because most movements of the end effector 10 involve movement of the medial assembly 470 relative to the proximal assembly 450 and/or distal assembly 480, said medial assembly 470 is involved with a majority of the movements of the thumb assembly 40. As discussed above, this is in contrast to conventional end effectors and/or conventional fingers and is beneficial because it reduces complexities, reduces components, increases reliability, and many other benefits that are obvious to one of skill in the art.

### 1. Main Medial Link

The primary or main medial link or fifth bar 474.1 is best shown in FIGS. 58-64. The main medial link 474.1 includes: (i) left and right medial frame members 474.1.1a, 474.1.1b, (ii) proximal link bridge 474.1.2, and (iii) medial link recess 474.1.3. The left and right medial frame members 474.1.1a, 474.1.1b include: (i) metacarpophalangeal joint openings 474.1.1.1a, 474.1.1.1b, (ii) interphalangeal joint openings 474.1.1.2a, 474.1.1.2b, (iii) PCB projections 474.1.1.3 configured to allow the PCB 476 to be offset from the frame member 474.1.1b, and (iv) housing mounting projections 474.1.1.4 are configured to couple the medial housing assembly 472 to said main medial link 474.1. As shown in the Figures, the first end of the primary or main medial link or fifth bar 474.1 is pivotally coupled to the primary or main proximal link or first bar 454.1 at the seventh pivot point P₇ and at the metacarpophalangeal joint MCP, while the second end primary or main medial link or fifth bar 474.1 is pivotally coupled to the primary or main distal link or seventh bar 484.1 at the eighth pivot point P₈ and at the interphalangeal joint IPJ. It should be understood that the first end of the primary or main medial link or fifth bar 474.1 include the metacarpophalangeal joint openings 474.1.1.1a, 474.1.1.1b, while the second end of the primary or main medial link or fifth bar 474.1 include interphalangeal joint openings 474.1.1.2a, 474.1.1.2b. It should be understood that this disclosure contemplates omitting one or more of these components or altering their configuration.

The left and right medial frame members 474.1.1a, 474.1.1b are coupled to one another via a medial link bridge 474.1.2. The combination of the left and right medial frame members 474.1.1a, 474.1.1b and medial link bridge 474.1.2 from a U-shaped member. Wherein the U-shaped member includes a medial link recess 474.1.3. Said medial link recess 474.1.3 is configured to receive an extent of the medial link assembly 474, wherein the position of various components in the medial link assembly 474 may move or shift when the position of the digit assembly 404 is altered. It should be understood that in other embodiments the medial link bridge 474.1.2 may be omitted, and the frame members 474.1.1a, 474.1.1b may be connected via a metacarpophalangeal joint assembly 474.5 and an interphalangeal joint assembly 474.6. Additionally, as shown in the Figures, an extent of the main proximal link 454.1 is positioned within the main medial link 474.1 and specifically within the main medial link 474.1 overlies the medial assembly recess 454.1.1.3.2 of the first and second proximal frame members 454.1.1a,b. This interlocking nature of the disclosed end effector 10 increases the reliability of said robot system.

A bushing 474.5.1, an axel 474.5.2, and a washer 474.5.3 form the metacarpophalangeal joint assembly 474.5 and wherein an extent of said metacarpophalangeal joint assembly 474.5 is positioned within the metacarpophalangeal joint openings 474.1.1.1a, 474.1.1.1b and extends between the first and second medial frame members 474.1.1a, 474.1.1b. Meanwhile, a bushing 474.6.1, an axel 474.6.2, and a washer 474.6.3 form the interphalangeal joint assembly 474.6 and wherein an extent of said interphalangeal joint assembly 474.6 is positioned within the interphalangeal joint openings 474.1.1.2a, 474.1.1.2b and extends between the first and second medial frame members 474.1.1a, 474.1.1b. The combination of the metacarpophalangeal joint assembly 474.5 and the metacarpophalangeal joint openings 474.1.1.1a, 474.1.1.1b forms the sixth pivot point P₆, while the combination of the interphalangeal joint assembly 474.6 and the interphalangeal joint openings 474.1.1.2a, 474.1.1.2b forms the eight pivot point P₈.

### 2. Medial Drive Link and Biasing Assembly

The medial drive link, or sixth bar 474.2 is best shown in FIGS. 20-24, 58-59, and 65-67. The medial drive link 474.2 includes a: (i) proximal drive link yoke 474.2.1, (ii) an elongated segment 474.2.2, and (iii) a distal link opening 474.2.3. The proximal drive link yoke 474.2.1 is designed to receive an extent of both of: (i) the worm drive link 454.4.3, and (ii) the jumper 454.4.4. After yoke 474.2.1 receives both the worm drive link 454.4.3 and the jumper 454.4.4, a securement means is inserted into an extent of the proximal drive link opening 454.4.4.1, main link opening 454.4.4.2, and the proximal drive link opening 454.4.3.2. The coupling of these three linkages 474.2, 454.4.3, and 454.4.4 creates a fifth pivot point P₅ after a securement means is inserted into each of these openings. Additionally, the coupling of the distal assembly 480 to the medial drive link 474.2 by inserting a securement means within the distal link opening 474.2.3 forms a seventh pivot point P₇. It should be understood that both of the disclosed securement means should be sufficiently rigid to withstand that movement and torque of said motors 412, 418. However, in other embodiments, the disclosed interlocking or nesting of these components may be omitted and/or the coupling of three separate bars at a single central point may be altered. For example, the medial drive link 474.2 may be coupled to one extent of the jumper 454.4.4 on a single side and the jumper 454.4.4 may be coupled to the worm drive link 454.4.3 on the opposite side of the jumper 454.4.4 at an alternative location that is different than the location where the medial drive link 474.2 is coupled.

A biasing projection 474.2.2.1 extends outward and depends from the frame member and is designed to receive an extent of the biasing assembly 474.4. It should be understood that said biasing projection 474.2.2.1 may be coupled to other members (e.g., main medial link 474.1) in other embodiments. Said biasing assembly 474.4 is best shown in FIGS. 21, 24, 57, 60, and 66-57, wherein said biasing assembly 474.4 includes the biasing member 474.4.1 and a biasing coupler 474.4.2. The biasing coupler 474.4.2 is configured to be positioned within a biasing assembly opening 474.3.3 of the Y-link 474.3, which enables said biasing member 474.4.1 to be positioned within a biasing assembly receiving 474.3.4 of said Y-link 474.3. The biasing member 474.4.1 may be a spring or any other known member (e.g., magnet, torsion bar, elastically deformable members, leaf spring, memory shape alloys, etc.) that can provide a biasing force on an extent of the thumb assembly 40 in order to control the order of closure/collapse of the components contained in said thumb assembly 40. In particular, when the thumb assembly 40 moves from the open, uncurled, or neutral position to the curled position, the biasing member 474.4.1 moves from a first or collapsed position with a length of L₁ to a second or extended position with a length L2. In the first or collapsed position, the biasing member 474.4.1 exerts a first biasing force F₁ that is less than a second biasing force F₂ that is exerted in the second or extended position. The biasing member 474.4.1 is designed to prevent the medial or distal assemblies 470, 480 before the proximal housing 452 has come into contact with a resistance point (e.g., an object). Once said proximal housing 452 has come into contact with a resistance point (e.g., an object), the main proximal link 454.1 and the proximal housing 452 stops moving. However, the motor assembly 410 can continue driving the worm drive gear 432.2.2 in a first direction, which turns the worm wheel 454.4.1, whereby causing the worm drive link 454.4.3 and the proximal drive link 454.4.3 to move into the proximal link recess 454.1.7 and rotation about the worm wheel axis AWW, thus forcing the biasing member 474.4.1 to expand for its original state, and therefore forces the medial and distal assemblies 470, 480 to curl inwards. The thumb assembly 40 can uncurl or return to its original position, if the motor assembly 410 drove driving the worm drive gear 432.2.2 in a second direction, which turns the worm wheel 454.4.1, whereby causing the worm drive link 454.4.3 and the proximal drive link 454.4.3 to move out of the proximal link recess 454.1.7, thus forcing the medial and distal assemblies 470, 480 to uncurl, therefore allowing the biasing member 474.4.1 to return to its original state, and consequently allowing the main proximal link 454.1 and the proximal housing 452 to return to their original position. It should be understood that other biasing members, structures, assemblies, or components may be used instead of the spring shown in the figures and in certain embodiments, that biasing assembly 474.7 may be eliminated.

### 3. Y-Link

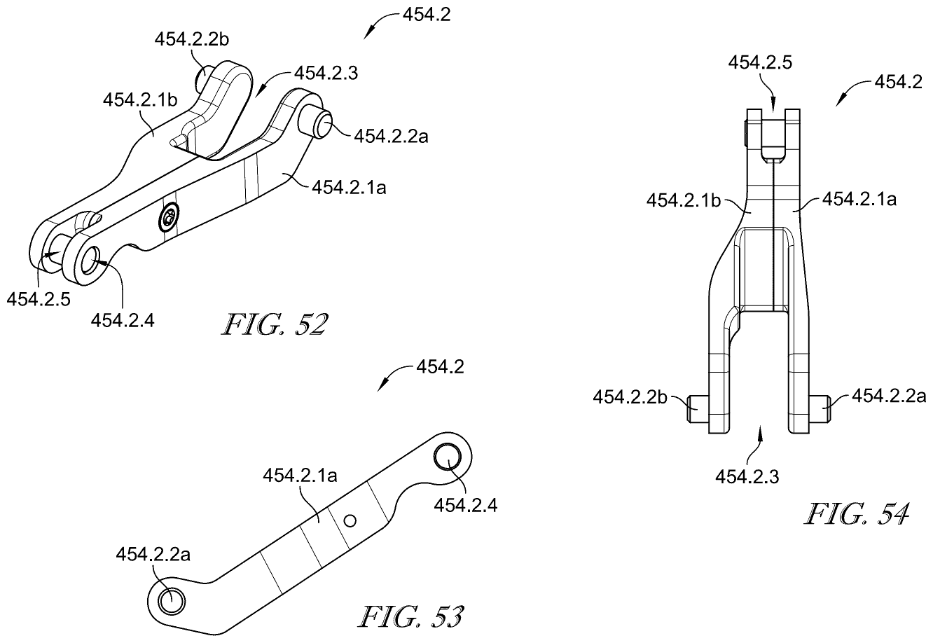

As best shown in FIGS. 52-54, the Y-link or seventh bar 474.3 is primarily configured to be coupled to an extent of the biasing assembly 474.4 and the main medial link 474.1. To accomplish this, the Y-link 474.3 includes: (i) a coupling link opening 474.3.1, (ii) a securement opening 474.3.2, (iii) a biasing assembly opening 474.3.3, and (iv) a biasing assembly receiver 474.3.4. The coupling link opening 474.3.1 is designed to receive a securement member (e.g., pin) that extends through the Y-link opening 454.2.4 of the coupling link 454.2, whereby pivotally coupling said Y-link 474.3 to the coupling link 454.2 at the fourth pivot P₄ point. While the fourth pivot P₄ point is formed at the center of the coupling link opening 474.3.1, a pivot point is not formed at the center of the securement opening 474.3.2. Instead, the securement opening 474.3.2 is configured to receive an extent of a fastener (e.g., screw) in order to couple said Y-link 474.3 to an extent of the main medial link 474.4. Based on this configuration, it should be understood that the Y-link 474.3 may be eliminated in certain embodiments. In these embodiments, the attributes of the Y-link 474.3 may be incorporated into the main medial link 474.1. As described in greater detail below, the frontal end of the Y-Link that includes the biasing assembly opening 474.3.3 is designed to receive an extent of the biasing member 474.4.1, and wherein said biasing member 474.4.1 is secured to the Y-Link via insertion of biasing coupler 474.4.2 thought both an extent of the biasing member 474.4.1 and the biasing assembly receiver 474.3.4. It should be understood that in other embodiments, the biasing member 474.4.1 may be integrally formed with the Y-link 474.3 and thus, various structures described herein may be omitted or modified.

c. Distal Assembly

The distal assembly 480 is positioned forward of the medial assembly 470 and is the third portion of the thumb assembly 40 configured to move relative to the palm 610. The distal assembly 480 includes: (i) a distal housing assembly 482, and (ii) a distal link assembly 484.

i. Distal Housing Assembly

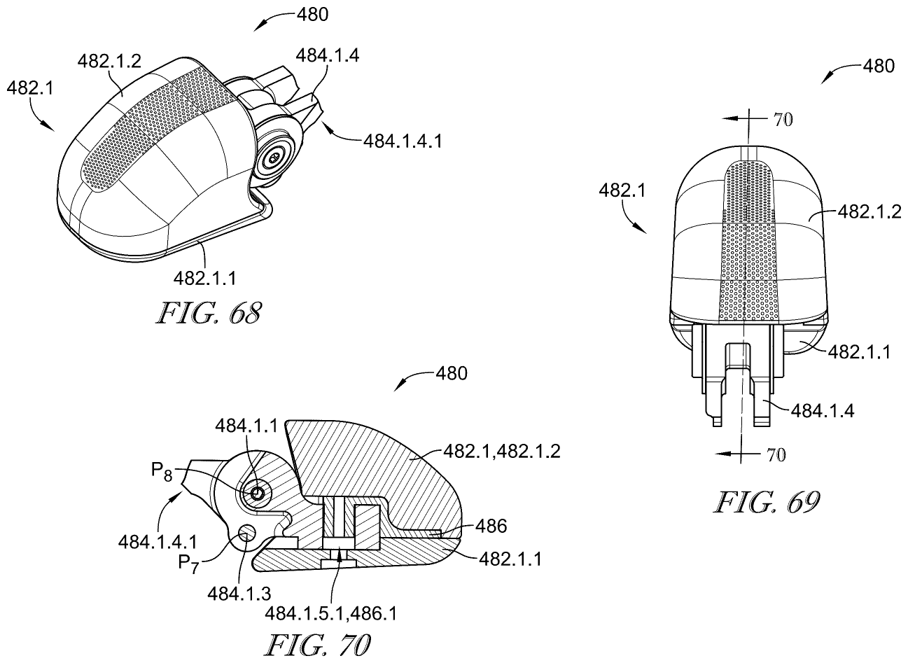

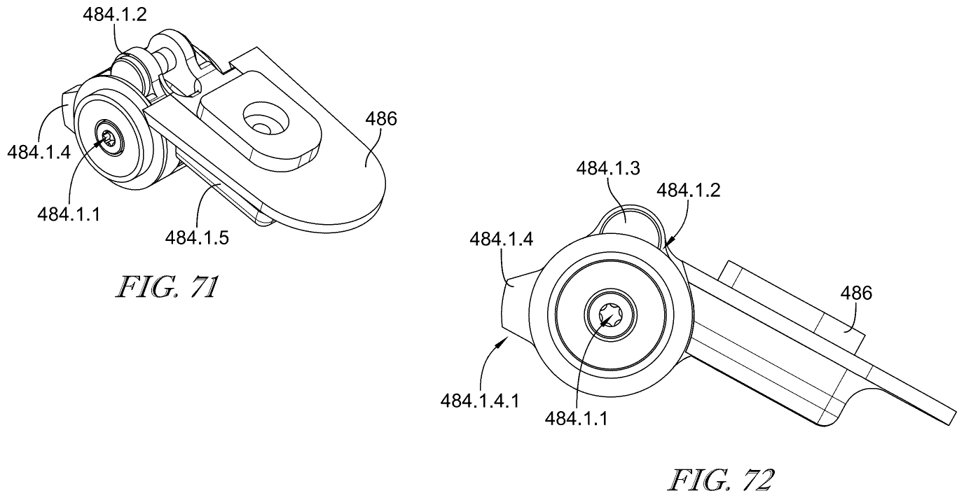

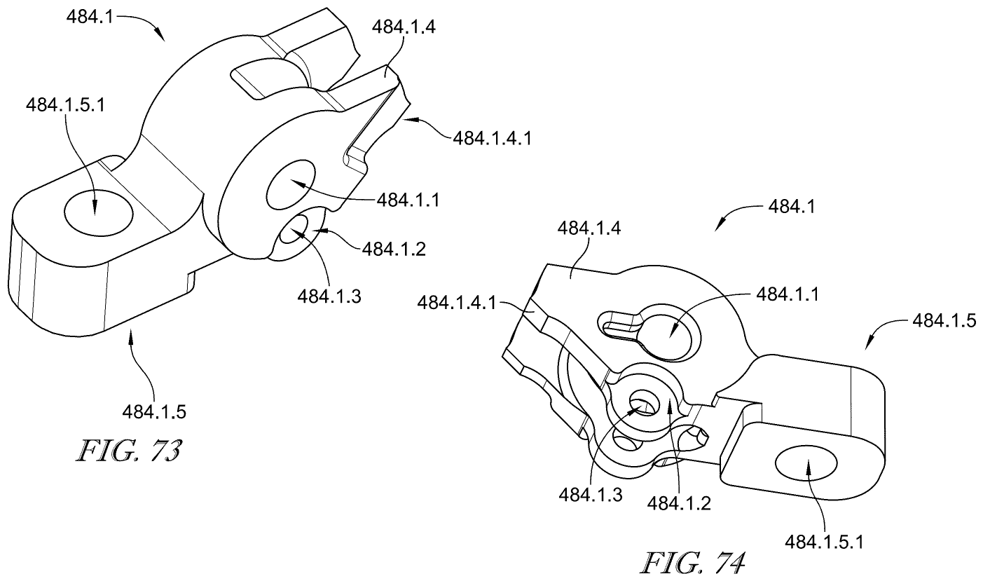

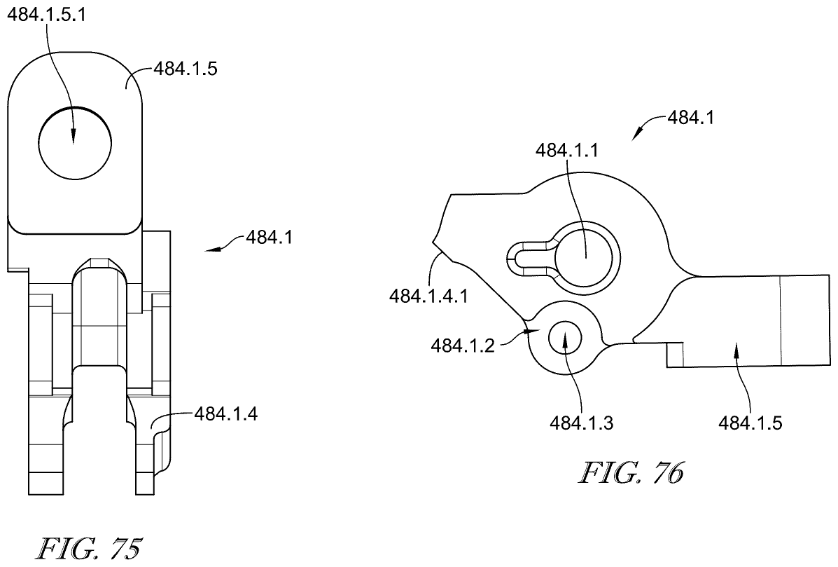

As shown in FIGS. 20-24 and 68-76, the distal housing assembly 482 is designed to substantially surround a majority of the other components of the distal assembly 480. To achieve this, the distal housing assembly 482 forms an internal distal recess 482.18 and specifically includes: (i) a distal jacket assembly 482.1 with a top member 482.1.1 and a bottom member 482.1.2, and (ii) a distal bottom casing assembly 482.2. While the bottom member 482.1.2 is in direct contact with and underlies the distal bottom casing assembly 482.2, the thumb assembly 40 lacks a distal top casing assembly that is in direct contact with the top member 482.1.1. This design is advantageous because the distal bottom casing assembly 482.2 provides the bottom member 482.1.2 with additional rigidity, which enables said bottom member 482.1.2 to be made from a softer, easier-to-form, and potentially less durable material, thereby increasing the gripping capability of the end effector 10. In contrast, the top member 482.1.1 does not need to include a softer, easier-to-form, and potentially less durable material because said top member 482.1.1 is not designed to come into regular contact with objects. Additionally, even if the materials of the distal bottom casing assembly 482.2 and the bottom member 482.1.2 are the same, it may be desirable to form these components as two separate components to facilitate replicability without exposing an inner extent of the thumb assembly 40. Another way of describing this beneficial configuration includes the fact that the distal jacket assembly 482.1 is configured to provide the primary external shape of the thumb assembly 40, while the distal casing assembly 482.2 is configured to protect the distal link assembly 484. Nevertheless, it should be understood that in an alternative embodiment, the bottom member 482.1.2 and the distal bottom casing assembly 482.2 may be integrally formed as a single structure.

As best shown in FIGS. 20-24, the top member 482.1.1 of the distal jacket assembly 482.1 includes an exterior surface back with a curvilinear extent in a first direction (namely, across the width of the thumb assembly 40), and the bottom member 482.1.2 of the distal jacket assembly 482.1 includes an exterior palm surface that is curvilinear extent in the first direction (namely, across the width of the thumb assembly 40) and a second direction (namely, across the length of the thumb assembly 40). The curvilinear extent in the first direction helps ensure that the thumb assembly 40 has rounded edges to help with grasping objects, while the curvilinear extent in the second direction helps ensure that the finger can curl inward. Additionally and as discussed above, the top member 482.1.1 of the distal jacket assembly 482.1 includes a rearwardly extending distal tongue 482.20. The distal tongue 482.20 has an arched shape with a curvilinear rear surface 482.20.2, wherein the width of said distal tongue 482.20 is reduced from a first or front width to a second or rear width. As such, the distal tongue 482.20 includes curvilinear extents in at least two directions. As discussed above, the distal tongue 482.20 is designed to be positioned within or adjacent to medial housing assembly 472 and configured to minimize the gap G₃ that is formed between assemblies 270 and 480. It should be understood that in an alternative embodiment, the distal tongue 482.20 may be omitted.

As discussed above, the distal housing assembly 482 may be: (i) made from the same materials as the housing assembly 60, (ii) made from materials that differ from the materials used in the housing assembly 60, and/or (iii) may include silicon, plastic (e.g., may include a polymer composition), carbon composite, or metal, a combination of these materials, and/or any other know material used in robot systems. Alternatively, the distal housing assembly 482 may include additional components or layers (e.g., between three and an nth). It should be also be understood in alternative embodiments that the distal jacket assembly 482.1 and the distal casing assembly 482.2 may be combined into a single component and/or additional exterior members may be added to the end effector 10/thumb assembly 40.

v. Distal Link Assembly

As shown in FIGS. 20-24 and 68-76, the distal link assembly 484 includes primary or main distal link or seventh bar 484.1 having: (i) interphalangeal opening 484.1.1, (ii) coupler recess 484.1.2, (iii) a medial drive link opening 484.1.3, (iv) limiting projections 484.1.4 with a fourth limiting interface region 484.1.4.1, and (v) a tip projection 484.1.5 with a tip opening 484.1.5.1. The distal link assembly 484 is involved in the least number of movements of the thumb assembly 40 compared to the number of movements involving the proximal and medial assemblies 450, 470. As discussed above, this is in contrast to conventional end effectors and/or conventional fingers and is beneficial because it reduces complexities, reduces components, increases reliability, and may have other benefits that are obvious to one of the skills in the art.

The interphalangeal opening 484.1.1 is configured to receive a securement means that couples said main distal link 484.1 to the main medial link 474.1 in order to form the ninth pivot point P₉. The coupler recess 484.1.2 is formed near the interphalangeal opening 484.1.1 and is designed to have the medial drive link opening 484.1.3 positioned therein to help ensure that the securement means that couples the medial drive link 474.2 to the main distal link 484.1 does not interfere with other parts or components of the thumb assembly 40. Finally, the limiting projections 484.1.4 with the fourth limiting interface region 484.1.4.1 are designed to interact with an extent of the main medial link 474.1 to help ensure that the distal assembly 480 does not over-curl or move backward (e.g., away from the palm 602).

### D. Industrial Application

While the disclosure shows illustrative embodiments of a robot (in particular, a humanoid robot), it should be understood that embodiments are designed to be examples of the principles of the disclosed assemblies, methods and systems, and are not intended to limit the broad aspects of the disclosed concepts to the embodiments illustrated. As will be realized, the disclosed robot, and its functionality and methods of operation, are capable of other and different configurations and several details are capable of being modified all without departing from the scope of the disclosed methods and systems. For example, one or more of the disclosed embodiments, in part or whole, may be combined with a disclosed assembly, method and system. As such, one or more steps from the diagrams or components in the Figures may be selectively omitted and/or combined consistent with the disclosed assemblies, methods and systems. For example, end effector 10 may lack traditional sensors (e.g., pressure, force, etc.) found in a conventional end effector 10. Additionally, those skilled in the art would recognize that many features of the implementation can be grouped together, split apart, reorganized, removed, or duplicated. Further, one or more steps from the arrangement of components may be omitted or performed in a different order. Accordingly, the drawings, diagrams, and detailed description are to be regarded as illustrative in nature, not restrictive or limiting, of the said humanoid robot.

While the above-described robot is designed as a head for use with a general-purpose humanoid robot, it should be understood that its assemblies, components, learning capabilities, and/or kinematic capabilities may be used with other robots. Examples of other robots include: articulated robot (e.g., an arm having two, six, or ten degrees of freedom, etc.), a cartesian robot (e.g., rectilinear or gantry robots, robots having three prismatic joints, etc.), Selective Compliance Assembly Robot Arm (SCARA) robots (e.g., with a donut shaped work envelope, with two parallel joints that provide compliance in one selected plane, with rotary shafts positioned vertically, with an end effector attached to an arm, etc.), delta robots (e.g., parallel link robots with parallel joint linkages connected with a common base, having direct control of each joint over the end effector, which may be used for pick-and-place or product transfer applications, etc.), polar robots (e.g., with a twisting joint connecting the arm with the base and a combination of two rotary joints and one linear joint connecting the links, having a centrally pivoting shaft and an extendable rotating arm, spherical robots, etc.), cylindrical robots (e.g., with at least one rotary joint at the base and at least one prismatic joint connecting the links, with a pivoting shaft and extendable arm that moves vertically and by sliding, with a cylindrical configuration that offers vertical and horizontal linear movement along with rotary movement about the vertical axis, etc.), self-driving car, a kitchen appliance, construction equipment, or a variety of other types of robot systems. The robot system may include one or more sensors (e.g., cameras, temperature, pressure, force, inductive or capacitive touch), motors (e.g., servo motors and stepper motors), actuators, biasing members, encoders, housing, or any other component known in the art that is used in connection with robot systems. Likewise, the robot system may omit one or more sensors (e.g., cameras, temperature, pressure, force, inductive or capacitive touch), motors (e.g., servo motors and stepper motors), actuators, biasing members, encoders, housing, or any other component known in the art that is used in connection with robot systems.

In other embodiments, other configurations and/or components may be utilized. As is known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data. The software code is executable by the general-purpose computer. In operation, the code is stored within the general-purpose computer platform. At other times, however, the software may be stored at other locations and/or transported for loading into the appropriate general-purpose computer system.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. The server functions may be implemented in a distributed fashion on a number of similar platforms, to distribute the processing load.

Hence, aspects of the disclosed methods and systems outlined above may be embodied in programming. Program aspects of the technology may be thought of as “products” or “articles of manufacture” typically in the form of executable code and/or associated data that is carried on or embodied in a type of machine-readable medium. “Storage” type media includes any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

A machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the disclosed methods and systems. Volatile storage media include dynamic memory, such as the main memory of such a computer platform. Tangible transmission media include coaxial cables, copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It is to be understood that the invention is not limited to the exact details of construction, operation, exact materials or embodiments shown and described, as obvious modifications and equivalents will be apparent to one skilled in the art. While the specific embodiments have been illustrated and described, numerous modifications come to mind without significantly departing from the spirit of the invention, and the scope of protection is only limited by the scope of the accompanying Claims. It should also be understood that substantially utilized herein means a deviation less than 15% and preferably less than 5%. It should also be understood that other configuration or arrangements of the above-described components is contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

In this Application, to the extent any U.S. patents, U.S. patent applications, or other materials (e.g., articles) have been incorporated by reference, the text of such materials is only incorporated by reference to the extent that they do not conflict with materials, statements and drawings set forth herein. In the event of such conflict, the text of the present document controls, and terms in this document should not be given a narrower reading in virtue of the way in which those terms are used in other materials incorporated by reference. It should also be understood that structures and/or features not directly associated with a robot cannot be adopted or implemented into the disclosed humanoid robot without careful analysis and verification of the complex realities of designing, testing, manufacturing, and certifying a robot for completion of usable work nearby and/or around humans. Theoretical designs that attempt to implement such modifications from non-robotic structures and/or features are insufficient (and in some instances, woefully insufficient) because they amount to mere design exercises that are not tethered to the complex realities of successfully designing, manufacturing and testing a robot.

1. An underactuated end effector for a humanoid robot, the underactuated end effector comprising:
a frame;
a plurality of finger assemblies removably connected to the frame, wherein each finger assembly of the plurality of finger assemblies includes a finger motor assembly; and
a thumb assembly removably connected to the frame, the thumb assembly comprising:
a first thumb motor with a first motor shaft, wherein the first motor shaft is rotatable about a first motor shaft axis;
a first motor gear connected to the first motor shaft and being rotatable about: the first motor shaft, and a first motor gear axis that is coaxial the first motor shaft;
a second thumb motor with a second motor shaft, wherein the second motor shaft is rotatable about a second motor shaft axis;
a second motor gear connected to the second motor shaft and configured for rotation about: the second motor shaft, and a second motor gear axis that is coaxial with the second motor shaft; and
wherein (i) the first motor shaft axis is oriented substantially parallel to the second motor shaft axis, and (ii) the first motor gear axis is oriented substantially parallel to the second motor gear axis.

2. The underactuated end effector of claim 1, wherein the thumb assembly further comprises:
a worm wheel that is configured to facilitate movement of the thumb assembly between an uncurled position and a curled position, and
a thumb drive assembly that is in geared engagement with the first motor gear and the worm wheel.

3. The underactuated end effector of claim 2, wherein the thumb drive assembly includes:
(i) a flexion gear in geared engagement with the first motor gear, (ii) a worm drive gear in geared engagement with the worm wheel, and (iii) a drive shaft coupled to both the flexion gear and the worm drive gear.

4. The underactuated end effector of claim 2, wherein the flexion gear is rotatable about a flexion axis, wherein the flexion axis is oriented perpendicular to both the first motor gear axis and the first motor shaft axis.

5. The underactuated end effector of claim 2, wherein the thumb assembly includes:
a thumb frame with an upper frame member that is removably connected to the thumb drive assembly and the frame, and
a lower frame member that is rotatable in response to rotation of the second motor shaft.

6. The underactuated end effector of claim 5, wherein the thumb drive assembly further includes an anterposition gear that is both: coupled to the lower frame member and in geared engagement with the second motor gear.

7. The underactuated end effector of claim 1, wherein each finger assembly of the plurality of finger assemblies further includes:
a metacarpophalangeal joint;
a proximal finger interphalangeal joint; and
a distal finger interphalangeal joint.

8. The underactuated end effector of claim 1, wherein the frame includes a palm region, and wherein the first thumb motor and the second thumb motor are at least partially received within the palm region of the frame.

9. The underactuated end effector of claim 1, wherein the thumb assembly further comprises:
a main proximal link that is pivotally connected to the thumb frame;
a main medial link that is pivotally connected to the main proximal link;
a main drive link that is pivotally connected to the main medial link; and
wherein the first thumb motor is configured to rotatably actuate the main proximal and medial links about a worm wheel axis.

10. The underactuated end effector of claim 1, wherein the thumb assembly lacks a mechanical cable configured to actuate any component of the thumb assembly.

11. The underactuated end effector of claim 1, the thumb assembly further comprising:
a carpometacarpal joint housing assembly having a base joint receiver;
a proximal housing assembly including a rear extent that is positioned within the base joint receiver when the thumb assembly is in an uncurled position, and wherein said rear extent of the proximal housing assembly is not positioned within the base joint receiver when the thumb assembly is in a curled position.

12. The underactuated end effector of claim 1, wherein the thumb assembly lacks both a pressure sensor and a force sensor, and wherein the thumb assembly is configured to covered within a textile covering.

13. The underactuated end effector of claim 1, wherein the thumb assembly further comprises a biasing member having a first extent connected to the proximal link and a second extent connected to the medial drive link, and wherein the biasing member is configured to bias the medial drive link toward an uncurled position.

14. The underactuated end effector of claim 1, wherein the end effector further comprises:
a palm housing that overlies an extent of the first and second thumb motors, and
a carpometacarpal joint housing assembly configured to rotate in response to rotation of the first motor shaft, wherein the carpometacarpal joint housing assembly includes an upper edge that is positioned proximate to a lower extent of the palm housing.

15. An underactuated end effector for a humanoid robot, the end effector comprising:
a frame;
a plurality of finger assemblies connected to the frame, each finger assembly of,
the plurality of finger assemblies comprising:
a metacarpophalangeal joint;
a proximal finger interphalangeal joint;
a distal finger interphalangeal joint; and
a thumb assembly removably connected to the frame, the thumb assembly comprising:
a first carpometacarpal joint;
a second carpometacarpal joint;
a metacarpophalangeal joint;
an interphalangeal joint;
a carpometacarpal encoder positioned proximate the first carpometacarpal joint and configured to collect data related to rotation of the first carpometacarpal joint;
a first thumb encoder positioned proximate the metacarpophalangeal joint and configured to collect data related to rotation of the metacarpophalangeal joint; and
a second thumb encoder positioned proximate the interphalangeal joint and configured to collect data related to rotation of the interphalangeal joint, and wherein the first thumb encoder and second thumb encoder are positioned adjacent to a main medial link of the thumb assembly.

16. The underactuated end effector of claim 15, wherein the thumb assembly further comprises: (i) a first motor gear, (ii) a worm wheel configured to facilitate movement of the thumb assembly between an uncurled position and a curled position, and (iii) a thumb drive assembly in geared engagement with the first motor gear and the worm wheel.

17. The underactuated end effector of claim 16, wherein the thumb drive assembly further includes: (i) a flexion gear in geared engagement with the first motor gear, (ii) a worm drive gear in geared engagement with the worm wheel, and (iii) a drive shaft coupled to both the flexion gear and the worm drive gear.

18. The underactuated end effector of claim 15, wherein the frame includes a palm region, and wherein a first thumb motor and a second thumb motor are at least partially received within the palm region of the frame.

19. The underactuated end effector of claim 15, the thumb assembly further comprising:
a carpometacarpal joint housing assembly having a base joint receiver; and
a proximal housing assembly including a rear extent that is positioned within the base joint receiver when the thumb assembly is in an uncurled position, wherein said rear extent of the proximal housing assembly is positioned external to the base joint receiver when the thumb assembly is in a curled position.

20. The underactuated end effector of claim 15, wherein the thumb assembly is configured to covered by a textile covering, and wherein the thumb assembly lacks a mechanical cable that actuates a component of the thumb assembly.

21. The underactuated end effector of claim 15, wherein the thumb assembly further comprises:
a first thumb motor with a first thumb motor shaft, wherein the first thumb motor shaft is configured to rotate about a first motor shaft axis;
a first motor gear connected to the first thumb motor shaft and configured for rotation about both: the first motor shaft and a first motor gear axis that is coaxial with the first motor shaft;
a second thumb motor with a second thumb motor shaft, and wherein the second thumb motor shaft is configured to rotate about a second motor shaft axis;
a second motor gear connected to the second thumb motor shaft and configured for rotation about both: the second motor shaft, and a second motor gear axis that is coaxial with the second motor shaft; and
wherein the first motor shaft axis is oriented substantially parallel to the second motor shaft axis, and the first motor gear axis is oriented substantially parallel to the second motor gear axis.

22. A humanoid robot with an underactuated end effector, the end effector comprising:
an end effector frame;
a palm housing coupled to the end effector frame and having a sagittal plane;
a plurality of finger assemblies removably connected to a first side of the end effector frame, wherein the sagittal plane of the palm housing is aligned with a longitudinal plane of a finger assembly of the plurality of finger assemblies;
a thumb assembly removably connected to a second side of the end effector frame, the thumb assembly comprising:
a thumb motor assembly, the thumb motor assembly comprising:
a first thumb motor with a first thumb motor shaft, wherein the first thumb motor shaft is configured to rotate about a first motor shaft axis;
a second thumb motor with a second thumb motor shaft, wherein the second thumb motor shaft is configured to rotate about a second motor shaft axis;
wherein at least an extent of the first thumb motor and the second thumb motor are positioned between the frame and the palm housing; and
wherein both the first motor shaft axis and the second motor shaft axis are not arranged parallel to the sagittal plane.

23. The humanoid robot with the underactuated end effector of claim 22, wherein the end effector further comprises a carpometacarpal joint housing assembly configured to rotate in response to rotation of the first thumb motor shaft, wherein the carpometacarpal joint housing assembly includes an upper edge that is positioned proximate to a lower extent of the palm housing.

24. The humanoid robot with the underactuated end effector of claim 22, wherein the thumb assembly further comprises:
a worm wheel configured to facilitate the movement of the thumb assembly between an uncurled position and a curled position, and
a thumb drive assembly in geared engagement with a first motor gear and the worm wheel.

25. The humanoid robot with the underactuated end effector of claim 24, wherein the thumb drive assembly further includes: (i) a flexion gear configured to be in geared engagement with the first motor gear, (ii) a worm drive gear configured to be in geared engagement with the worm wheel, and (iii) a drive shaft coupled to both the flexion gear and the worm drive gear.

26. The humanoid robot with the underactuated end effector of claim 24, wherein the thumb assembly includes:
a thumb frame with an upper frame member configured to be removably connected to both the thumb drive assembly and the frame, and
a lower frame member that is rotatable in response to the rotation of the second thumb motor shaft.

27. The humanoid robot with the underactuated end effector of claim 26, wherein the thumb drive assembly further includes an anterposition gear that is coupled to the lower frame member, and is in geared engagement with a second motor gear.
